(19) United States
(12) Patent Application Publication
(10) Pub. No.: US 2026/0173034 A1
(43) Pub. Date: Jun. 18, 2026

(54) Methods and Apparatus for Supporting Adaptive Paging in a Communications System Based on Detected Network Conditions

(71) Applicant: Charter Communications Operating, LLC, St. Louis, MO (US)

(72) Inventor: Pareshkumar Panchal, Highlands Ranch, CO (US)

(21) Appl. No.: 18/981,438

(22) Filed: Dec. 13, 2024

(51) Int. Cl. H04W 68/02; H04W 52/02; H04W 76/28

(52) U.S. Cl. CPC H04W 68/02; H04W 52/0216; H04W 76/28

(57) ABSTRACT

Methods and apparatus for dynamically generating paging parameter recommendations for different network regions, e.g., tracking regions which are treated as separate regions for paging purposes, and implementing the recommendations are described. Network traffic data and/or activity report information is analyzed, e.g., on a periodic basis for each region, to determine a level of paging in an individual region during a time period. The analysis may be based on the actual level of paging in the region and/or information such as traffic load indicative of the level of paging in the region. Based on the determined level of paging load in a region for a given time period paging parameters to be used are determined. The paging parameter recommendations include recommendations for a paging drx-onDuration Timer value and a paging drx-Inactivity Timer value to be used in a region for the time period to which the analyzed information corresponds.

### FIELD

The present invention is directed to wireless communications, and more particularly, to methods and apparatus for supporting adaptive paging in a communication system based on detected network conditions.

### BACKGROUND

In a wireless network, base stations may page User Equipments (UEs) when the UE is in not in a fully active state, e.g., when a UE for which a communication is to be sent is in an RRC_IDLE or RRC_INACTIVE state. The page can trigger a UE to which it is directed to change states to a state in which it can receive data, e.g., corresponding to a communications session, from a base station via a radio connection.

FIG. 1 is a state diagram 100 from 3GPP TS 38.331 V 18.3.0 dated September 2024, (hereinafter 3GPP TS 38.331) which is hereby expressly incorporated by reference in its entirety, in FIG. 4.2.1-1 shows UE state machine and state transitions in NR. State diagram 100 of FIG. 1 illustrates NR RRC_IDLE state 102, NR_RRC_CONNECTED state 104, NR RRC_INACTIVE state 106 and possible state transitions, as indicated by bi-directional arrow 108, bi-directional arrow 110 and uni-directional arrow 112. Thus FIG. 1 shows how a UE can transition between various states. As shown in FIG. 1 a UE can transition from a NR RRC_INACTIVE state 104 or a NR RRC_IDLE state 102 back to an NR RRC_CONNECTED state 106. A paging message, if received by a UE and intended for the UE, can trigger the UE to transition from the NR RRC_IDLE state 102 or NR RRC_INACTIVE state 104 to the NR RRC_CONNECTED state.

Thus, it should be appreciated that in a wireless network, a paging procedure can be initiated, and a page transmitted by one or more base stations in a tracking area, to a UE in RRC_IDLE and RRC_INACTIVE state. The network may address multiple UEs within a paging message including one paging record for each UE. For a UE to detect and respond to paging messages, the UE needs to be frequently wake-up, listen and wait for the paging message on specific paging frame and paging occasions so that it can detect a paging message if one is sent relating to the UE performing the monitoring. Often all devices in multiple base station areas (served by single tracking area) have to wake up during these frames and occasions used for paging message transmission.

Waking up and monitoring for paging messages requires power and thus impacts devices battery drain and the time possible between battery charges. In cases where battery drain requires a user to frequently charge a wireless device, it will compromise user experience.

In order to limit or reduce the impact of paging on battery power, idle mode DRX (Discontinuous Reception) is supported in at least some 3GPP standards and/or releases. It is a power saving technique for UEs or any such devices that allows periodically transit to low power mode during Idle periods. When the devices are not having any data to transmit or receive, they go into energy saving mode. It does periodically wake up to check for any incoming data and minimize energy consumption. DRX cycle defines the frequency and duration of active periods for listening paging occasions (POs).

Paging occasions (PO) are the instances for the network to inform devices of incoming calls, messages, data or any other notifications. A PO corresponds to a DRX cycle which, as shown in drawing 200 of FIG. 2 includes a first portion of time 204, e.g., an on duration, in which the UE monitors for paging messages, followed by an opportunity for DRX portion 206, in which the UE does not monitor for pages and thus can conserve power as compared to the portion of time 204 in which monitoring for paging messages is performed. Information block 205 indicates that the UE shall monitor PDCCH (Physical Downlink Control Channel) for pages starting at the beginning of the On Duration 204 of the DRX cycle 202.

In order to control the frequency and amount of time spent by UEs during a paging period, the duration of the period 204 in which a UE monitors for pages can be set by using a drx-onDurationTimer parameter which can be used to set the period 204 for monitoring for pages from a duration in the range of: 1 ms to 1600 ms with the value being, as specified in TS 38.321, in multiples of 1/32 ms (subMilliSeconds) or in ms (milliSecond). For the latter, value ms1 corresponds to 1 ms, value ms2 corresponds to 2 ms, and so on.

In accordance with the standard, a network can configure a drx-onDurationTimer value for a second DRX group that is smaller than a drx-onDurationTimer configured for a default DRX group in IE DRX-Config as specified in TS38.331.

In addition to specifying an on duration, TS38.331 allows a network to set a drx-InactivityTimer to a value in the range of 0 ms to 2560 ms to set the duration of a DRX inactivity period which may be, and sometimes is, included in a DRX cycle.

drx-InactivityTimer values are specified in the form of values which are integer multiples of 1 ms. For example, ms0 corresponds to 0 ms, ms1 corresponds to 1 ms, ms 2 corresponds to 2 ms, and so on, as specified in TS 38.321. In accordance with the standard, a network can configure a drx-InactivityTimer value for the second DRX group that is smaller than the drx-InactivityTimer configured for the default DRX group in IE DRX-Config. The drx-InactivityTimer specifies the duration a device waits before it goes into idle mode after successful decoding of the pdcch. See, for example, TS38.331 which is hereby expressly incorporated by reference.

The drx-onDurationTimer value and drx-InactivityTimer value are normally set in a network often taking into consideration the maximum predicted paging load during which the settings are to remain in effect, with the settings left fixed or unchanged for long periods of time, e.g., days or weeks. While setting these parameters based on a predicted maximum paging load that is likely to be encountered during a long period of time increases the chances that paging messages will be successful received in a tracking area for which the settings are applied, it can lead to excessive battery drain due to UEs monitoring for pages more frequency than actually required given that during some periods of time actual paging requirements may fall far below the maximum predicted paging load used for determining the settings. This is because paging load and/or the number of UEs in a tracking area may vary significantly during a day or week, e.g., on an hourly basis, as users move into or out of an area as part of a regular communicate or as routine activities change in an area throughout the day.

In view of the above it should be appreciated that there is a need for improved methods and apparatus for determining and controlling paging related parameters settings. In particular it would be desirable if methods and/or apparatus could be developed which could be used to determine, based on actual network loading and/or other conditions, what paging related parameter values should be used, when they should be changed, and/or how frequently they should be updated.

### SUMMARY

Methods and apparatus for dynamically generating paging parameter recommendations for different network regions, e.g., tracking regions which are treated as separate regions for paging purposes, and implementing the recommendations are described.

In various embodiments network traffic data and/or activity report information is analyzed, e.g., on a periodic recurring basis, to determine a level of paging in an individual region during a time period. The analysis may be based on the actual level of paging in the region and/or information such as traffic load indicative of the level of paging in the region.

Based on the determined level of paging load in a region for a given time period, recommended paging parameters are suggested, e.g., for use in a future corresponding time period such as a day of the week and hourly time period to which the network information which was analyzed corresponded. In some embodiments the paging parameters recommendations include recommendations for a paging drx-onDuration Timer value to be used in a region for the time period to which the analyzed information corresponds and a paging drx-Inactivity Timer value to be used in a region for the time period to which the analyzed information.

Since traffic and paging loads tend to recur over a weekly time period in a relatively consistent manner, the methods and apparatus allow for data based selection of paging parameter values rather than using fixed static values. Over time as the traffic/paging load in a region changes, the parameter values will be updated to reflect such changes in traffic and/or paging load.

In some embodiments paging parameters are recommended based on the determined paging load in a region with different paging load ranges mapping to different sets of predetermined paging parameter values. Thus by determining the paging load in a region for a time period, identifying the paging load range in which the determined paging load falls, the corresponding predetermined paging parameters corresponding to the identified paging load range will be recommended for use in the region to which the analysis relates during the time period, e.g., day of week and hourly time period within the day, to which the analysis relates.

The paging load and paging parameter process is performed in some embodiments for multiple regions with a recommended paging parameter schedule including the recommended paging parameters and time periods for which they are recommended being generated and communicated, e.g., from an analytic server performing the analysis and recommending paging parameters, to an operations support system. The generated paging parameter schedule can include information for a single region or multiple regions, e.g., tracking areas. The paging parameter recommendations are generated on a per region basis and thus different regions can be provided with the same or different paging parameter recommendations depending on the paging load that was determined in a given region. Thus, in some embodiments regions with paging loads falling in the same paging load range during a period of time will be recommended to use the same paging parameters, while regions with paging loads falling in different paging load ranges during a period of time will be recommended to use different paging parameters during upcoming iterations of the period of time.

While the paging parameters are indicated to be recommended paging parameters, this is because it is up to the operations support system to implement the paging parameters. In some embodiments the communication of recommended paging parameters is interpreted as a command to use the recommended paging parameters and in such an embodiment the recommended paging parameters are paging parameters to be used.

The operations support system (OSS) receives the recommended paging parameters, corresponding region information, and time period information indicating when the paging parameters are to be used. The receipt of such information may be in a paging parameter report.

The OSS provides the base station or base stations in regions for which paging parameter recommendations are made, the paging parameter information for the region in a timely manner so that the base stations in the region can perform paging and notify UEs in the region of the paging parameters to be used. Individual base stations in a region are normally provided paging parameter information relevant to the tracking area and/or paging region in which the base station is located. Thus, while a recommended paging parameter schedule sent to the OSS may include information for multiple regions, the paging parameter information sent from the OSS to base stations in a region normally is limited to information for the region in which the base station receiving the information is located. The base station will use the paging parameter information, e.g., the paging parameter values recommended by the analytics server and communicated by the OSS to the base station, to configure the base station and perform paging operations. The base station transmits, e.g., broadcast as part of system information, one or more of the paging parameters to notify UEs of the paging parameters to be used in a time period to which the transmitted information relates.

In accordance with the invention paging parameters used in a region can be updated dynamically based on analysis of actual paging load and/or network traffic in a region and/or other key performance indicators. In some embodiments the paging parameters are updated on at least a weekly basis but in other embodiments the updates are less frequent or more frequent. Weekly updates provide a reasonable update rate in many cases given that traffic patterns and thus paging loads tend to repeat over a weekly period. Similarly hourly intervals for traffic analysis and paging parameter recommendations are reasonable since traffic patterns tend to be reasonably stable over hourly periods with large changes in load often occurring around hourly boundaries due to work day and/or other events often being correlated with hourly clock time periods such as 5 pm being the end of the work day for many workers during weekdays.

While various features are discussed in the above summary, all features discussed above need not be supported in all embodiments and numerous variations are possible. Additional features, details and embodiments are discussed in the detailed description which follows.

### BRIEF DESCRIPTION OF THE FIGURES

FIG. 1 is a drawing which shows UE state machine and state transitions in NR.

FIG. 2 is drawing illustrating a DRX cycle.

FIG. 3 is a drawing illustrating an exemplary communications system in accordance with an exemplary embodiment.

FIG. 4A is a first part of an exemplary signaling diagram illustrating an exemplary method for supporting adaptive paging in a communications system based on detected network conditions in accordance with an exemplary embodiment.

FIG. 4B is a second part of an exemplary signaling diagram illustrating an exemplary method for supporting adaptive paging in a communications system based on detected network conditions in accordance with an exemplary embodiment.

FIG. 4 comprises the combination of FIG. 4A and FIG. 4B.

FIG. 5A is a first part of a flowchart of an exemplary method of operating an analytics server, e.g., to perform steps included in the signaling diagram of FIG. 4, in accordance with an exemplary embodiment.

FIG. 5B is a second part of a flowchart of an exemplary method of operating an analytics server, e.g., to perform steps included in the signaling diagram of FIG. 4, in accordance with an exemplary embodiment.

FIG. 5 comprises the combination of FIG. 5A and FIG. 5B.

FIG. 6 is a drawing of an exemplary core network node in accordance with an exemplary embodiment.

FIG. 7 is a drawing of an exemplary analytics server in accordance with an exemplary embodiment.

FIG. 8 is a drawing of an exemplary user equipment (UE) in accordance with an exemplary embodiment.

FIG. 9 is a drawing of an exemplary base station, e.g., a gNB, in accordance with an exemplary embodiment.

FIG. 10 is a drawing of an exemplary performance evaluator server in accordance with an exemplary embodiment.

FIG. 11 is a drawing of an exemplary operation support system (OSS) in accordance with an exemplary embodiment.

FIG. 12 is a drawing illustrating exemplary traffic demand in each of three different regions during a first time period.

FIG. 13 is a drawing illustrating exemplary traffic demand in each of three different regions during a second time period.

FIG. 14 is a drawing illustrating exemplary traffic demand in each of three different regions during a third time period.

FIG. 15 is a drawing illustrating exemplary traffic demand in each of three different regions during a fourth time period.

FIG. 16 is a drawing illustrating three exemplary pre-defined sets of paging parameter settings in accordance with an exemplary embodiment.

FIG. 17 is a drawing illustrating an exemplary generated recommended paging parameters schedule, corresponding to 3 regions, in accordance with an exemplary embodiment.

FIG. 18 is a drawing illustrating exemplary determined traffic load in three regions during time periods of a week, in accordance with an exemplary embodiment.

FIG. 19 is a drawing illustrating exemplary determined paging load in three regions during time periods of a week, in accordance with an exemplary embodiment.

FIG. 20 is a drawing illustrating an exemplary paging parameter schedule for a first region, in accordance with an exemplary embodiment.

FIG. 21 is a drawing illustrating an exemplary paging parameter schedule for a second region, in accordance with an exemplary embodiment.

FIG. 22 is a drawing illustrating an exemplary paging parameter schedule for a third region, in accordance with an exemplary embodiment.

### DETAILED DESCRIPTION

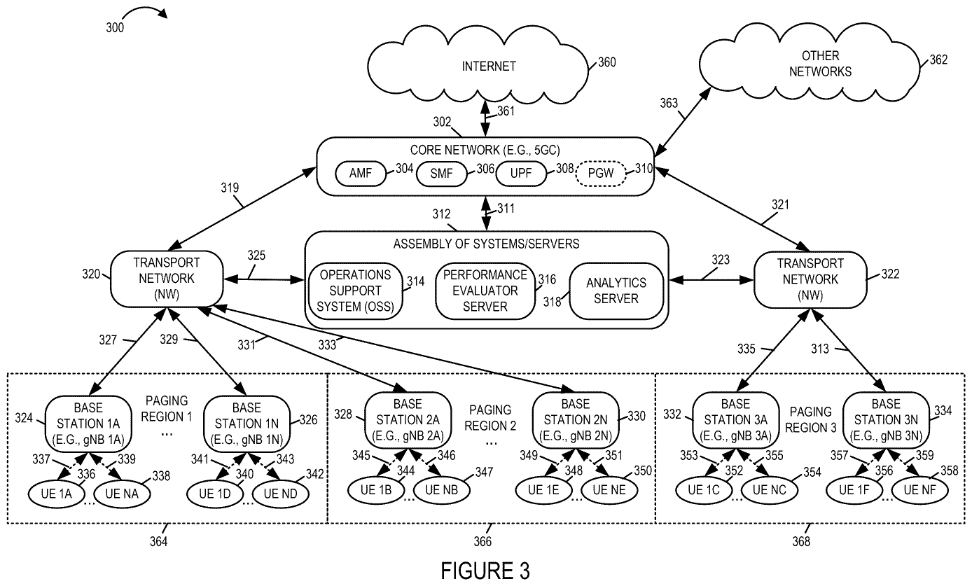

FIG. 3 is a drawing illustrating an exemplary communications system 300 in accordance with an exemplary embodiment. Exemplary communications system 300 includes a core network 302, an assembly of systems/servers 312, transports networks 320, 322, a plurality of base stations (base station 1A 324, gNB 1A, . . . , base station 1N 326, e.g., gNB 1N, base station 2A 328, e.g., gNB 2A, . . . , base station 2N, e.g., gNB 2N, . . . , base station 3A 332, . . . , e.g., gNB 3A, . . . , base station 3N 334, e.g., gNB 3N), Internet 360 and other networks 362 coupled together as shown. Exemplary communications system 300 further includes a plurality of user equipments (UE 1A 336, . . . UE NA 338, UE 1D 340, . . . , UE ND 342, UE 1B 344, . . . , UE NB 346, UE 1E 348, . . . , UE NE 350, UE 1C 352, . . . , UE NC 354, UE 1F 356, . . . , UE NF 358). At least some of the UEs are mobile wireless communications devices which may move throughout communications system 300 and be connected to different base stations at different times.

Core network 302, e.g., a 5G core (5GC) network, including one or more nodes implementing a plurality of functions including an access and mobility management function (AMF) 304, a session management function (SMF) 306, a user plane function (UPF) 308. In some embodiments, but not necessarily all embodiments, core network 302 including a PGW 310. Assembly of systems/servers 312 includes an operation support system (OSS) 314 including configuration management functionality, a performance evaluator server 316 for collecting network performance information from base station and/or UEs, said collected network performance information including network activity information, traffic demand information and other information related to paging, and an analytics server 318, e.g., for evaluating network performance information and for generated recommended paging parameter schedules corresponding to different regions. Transports networks 320, 324 includes routers, switches and/or other network devices, e.g., for coupling base stations to the core network and/or to assembly of systems/servers 311.

The plurality of base stations are grouped into paging regions. The set of base stations (base station 1A 324, . . . , base station 1N 326) are included as part of paging region 1 364. The set of base stations (base station 2A 328, . . . , base station 3N 330) are included as part of paging region 2 366. The set of base stations (base station 3A 332, . . . , base station 3N 334) are included as part of paging region 3 368.

In FIG. 3, UEs (UE 1A 336, . . . , UE NA 338) are shown coupled to base station 1A 324 via wireless links (337, . . . , 339), respectively. In FIG. 3 UEs (UE 1D 340, . . . , UE ND 342) are shown coupled to base station 1N 326 via wireless links (341, . . . , 343), respectively. In FIG. 3 UEs (UE 1B 344, . . . , UE NB 346) are shown coupled to base station 2A 328 via wireless links (345, . . . , 347), respectively. In FIG. 3, UEs (UE 1E 348, . . . , UE NE 350) are shown coupled to base station 2N 330 via wireless links (349, . . . , 351), respectively. In FIG. 3 UEs (UE 1C 352, . . . , UE NC 354) are shown coupled to base station 3A 332 via wireless links (353, . . . , 355), respectively. In FIG. 3 UEs (UE 1F 356, . . . , UE NF 358) are shown coupled to base station 3N 334 via wireless links (357, . . . , 359), respectively.

The base stations (base station 1A 324, base station 1N 326, base station 2A 328, base station 2N 330) are coupled to transport network (NW) 320 via communications links (327, 329, 331, 335), respectively. The base stations (base station 3A 332, base station 3N 334) are coupled to transport network (NW) 322 via communications links (335, 313), respectively. Transport network 320 is coupled to assembly of systems/server 312 via communications link 325. Transport network 320 is coupled to core network 302 via communications link 319. Transport network 322 is coupled to assembly of systems/server 312 via communications link 323. Transport network 322 is coupled to core network 302 via communications link 321. Core network 302 is coupled to assembly of systems/servers 312 via communications link 311. Core network 302 is coupled to Internet 360 via communications link 361 and is coupled to other networks 362 via communications link 363. Elements (314, 316, 318) within assembly of systems/server 312 may communicate with one another and/or other devices, e.g., core network nodes and base stations, e.g., via internal connections and/or external communications links.

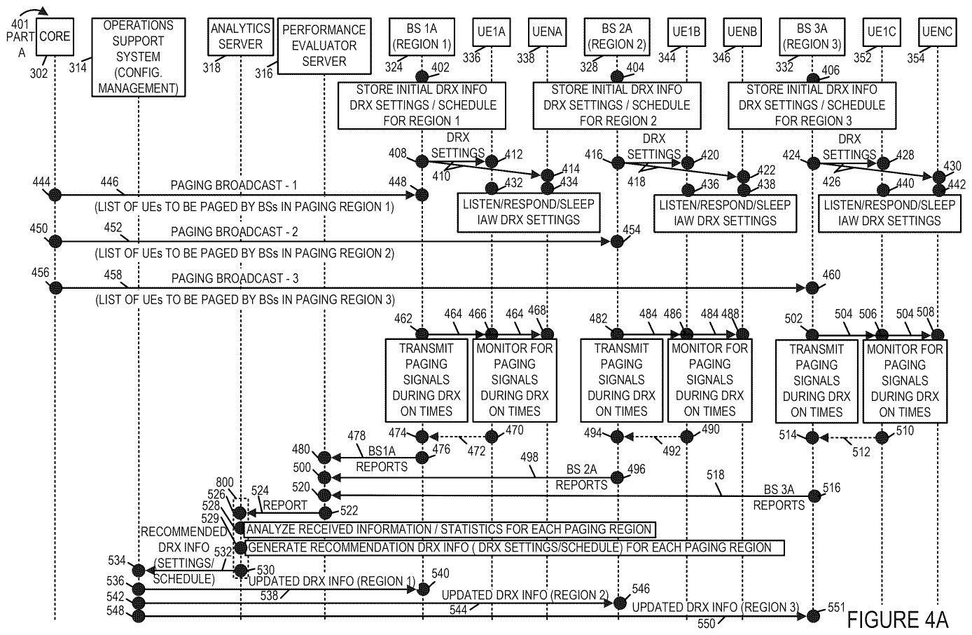

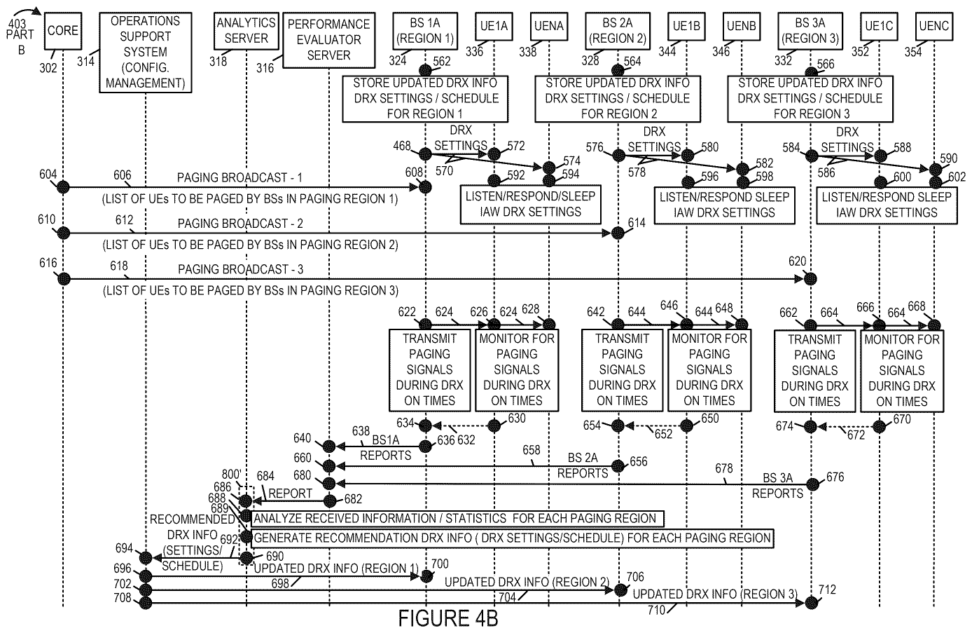

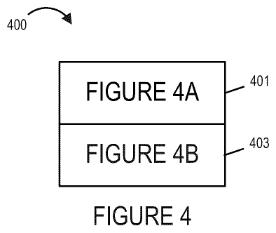

FIG. 4, comprising the combination of FIG. 4A and FIG. 4B, is a signaling diagram 400, comprising Part A 401 and Part B 403, of an exemplary method of operating a communications system, supporting adaptive paging based on detected network conditions, in accordance with an exemplary embodiment. The exemplary method of signaling diagram 400 of FIG. 4 is, e.g., implemented by communications system 300 of FIG. 3. The signaling diagram 400 of FIG. 4 illustrates exemplary signaling for one base station (BS 1A 324, BS 2A 328, BS 3A 332) in each region (paging region 1 364 of FIG. 3, paging region 2 366 of FIG. 3, paging region 3 368 of FIG. 3), respectively, for simplicity of illustration; however, it is to be understood that similar signaling exists for each of the other base stations (e.g., BS 1N 326, BS 2N 330, BS 3N 334) in system 300.

In step 402 BS 1A 324 stores initial DRX information, e.g. initial DRX settings/schedule information, for region 1. The initial DRX information is, e.g., an initial paging parameters schedule to be implemented by BS1A 324, said initial paging parameters schedule including a set of DRX parameter values (e.g., a drx-onDuration Timer value and a drx-InactivityTimer value) corresponding to each of one or more time intervals. In some embodiments the initial DRX information is pre-loaded in BS 1A 324. In other embodiments, the initial DRX information is downloaded into BS 1A 324 from OSS 314.

In step 404 BS 2A 328 stores initial DRX information, e.g. initial DRX settings/schedule information, for region 2. The initial DRX information is, e.g., an initial paging parameters schedule to be implemented by BS2A 328, said initial paging parameters schedule including a set of DRX parameter values (e.g., a drx-onDuration Timer value and a drx-InactivityTimer value) corresponding to each of one or more time intervals. In some embodiments the initial DRX information is pre-loaded in BS 2A 328. In other embodiments, the initial DRX information is downloaded into BS 2A 328 from OSS 314.

In step 406 BS 3A 332 stores initial DRX information, e.g. initial DRX settings/schedule information, for region 3. The initial DRX information is, e.g., an initial paging parameters schedule to be implemented by BS3A 332, said initial paging parameters schedule including a set of DRX parameter values (e.g., a drx-onDuration Timer value and a drx-InactivityTimer value) corresponding to each of one or more time intervals. In some embodiments the initial DRX information is pre-loaded in BS 3A 332. In other embodiments, the initial DRX information is downloaded into BS 3A 332 from OSS 314.

In step 408 BS 1A 324 generates and sends signals 410, e.g., broadcast signals, communicating DRX setting information (e.g., information indicating a drx-onDuration Timer value and a drx-InactivityTimer value) being implemented by BS 1A 324 for a time interval in accordance with the paging parameters schedule being implemented by BS 1A 324. In step 412 UE 1A 336 receives the signals 410, communicating the DRX setting information, determines the DRX settings information (e.g., drx-onDuration Timer value and drx-InactivityTimer value), and configures to operate using the communicated DRX settings. In step 414 UE NA 338 receives the signals 410, communicating the DRX setting information, determines the DRX settings information (e.g., drx-onDuration Timer value and drx-InactivityTimer value), and configures to operate using the communicated DRX settings.

In step 416 BS 2A 328 generates and sends signals 418, e.g., broadcast signals, communicating DRX setting information (e.g., information indicating a drx-onDuration Timer value and a drx-InactivityTimer value) being implemented by BS 2A 328 for a time interval in accordance with the paging parameters schedule being implemented by BS 2A 328. In step 420 UE 1B 344 receives the signals 418, communicating the DRX setting information, determines the DRX settings information (e.g., drx-onDuration Timer value and drx-InactivityTimer value), and configures to operate using the communicated DRX settings. In step 422 UE NB 346 receives the signals 418, communicating the DRX setting information, determines the DRX settings information (e.g., drx-onDuration Timer value and drx-InactivityTimer value), and configures to operate using the communicated DRX settings.

In step 424 BS 3A 332 generates and sends signals 426, e.g., broadcast signals, communicating DRX setting information (e.g., information indicating a drx-onDuration Timer value and a drx-InactivityTimer value) being implemented by BS 3A 332 for a time interval in accordance with the paging parameters schedule being implemented by BS 3A 332. In step 428 UE 1C 352 receives the signals 426, communicating the DRX setting information, determines the DRX settings information (e.g., drx-onDuration Timer value and drx-InactivityTimer value), and configures to operate using the communicated DRX settings. In step 430 UE NC 354 receives the signals 426, communicating the DRX setting information, determines the DRX settings information (e.g., drx-onDuration Timer value and drx-InactivityTimer value), and configures to operate using the communicated DRX settings.

In step 432 UE 1A 336 is operated to listen for pages, respond to pages, and sleep in accordance with (IAW) the configured DRX settings from step 412. In step 434 UE NA 338 is operated to listen for pages, respond to pages, and sleep IAW the configured DRX settings from step 414. In step 436 UE 1B 334 is operated to listen for pages, respond to pages, and sleep IAW the configured DRX settings from step 420. In step 422 UE NB 346 is operated to listen for pages, respond to pages, and sleep IAW the configured DRX settings from step 422. In step 440 UE 1C 352 is operated to listen for pages, respond to pages, and sleep IAW the configured DRX settings from step 428. In step 442 UE NC 354 is operated to listen for pages, respond to pages, and sleep IAW the configured DRX settings from step 430.

In step 444 core 302 generates and sends paging message 446 to each of the base stations in paging region 1 364 of FIG. 3, said message 446 indicating paging broadcasts for region 1, e.g., a list of UEs to be paged by BSs in paging region 1. In step 448 BS 1A 324 receives paging message 446 and recovers the communicated information, identifying the UEs to be paged by BS 1A 324.

In step 450 core 302 generates and sends paging message 452 to each of the base stations in paging region 2 366, said message 452 indicating paging broadcasts for region 2, e.g., a list of UEs to be paged by BSs in paging region 2. In step 454 BS 2A 328 receives paging message 452 and recovers the communicated information, identifying the UEs to be paged by BS 2A 328.

In step 456 core 302 generates and sends paging message 458 to each of the base stations in paging region 3 368, said message 458 indicating paging broadcasts for region 3, e.g., a list of UEs to be paged by BSs in paging region 3. In step 460 BS 3A 332 receives paging message 458 and recovers the communicated information, identifying the UEs to be paged by BS 3A 332.

In step 462 BS 1A 324 generates and transmits paging signals 464, to page UEs identified in message 446, during DRX on times. In steps 466 and 468 UEs (UE 1A 336, UE NA 338), respectively, monitor for paging signals during DRX on times, receive paging signals 464, and determine whether or not the UE is being paged. In this example, consider that UE 1A 336 is being paged. In step 470, UE 1A 336 generates and sends paging response signal 472 to BS 1A 324, which receives the paging response signal in step 474.

In step 482 BS 2A 328 generates and transmits paging signals 484, to page UEs identified in message 452, during DRX on times. In steps 486 and 488 UEs (UE 1B 344, UE NB 346), respectively, monitor for paging signals during DRX on times, receive paging signals 484, and determine whether or not the UE is being paged. In this example, consider that UE 1B 344 is being paged. In step 490, UE 1B 344 generates and sends paging response signal 492 to BS 2A 328, which receives the paging response signal in step 494.

In step 502 BS 3A 332 generates and transmits paging signals 504, to page UEs identified in message 458, during DRX on times. In steps 506 and 508 UEs (UE 1C 352, UE NC 354), respectively, monitor for paging signals during DRX on times, receive paging signals 504, and determine whether or not the UE is being paged. In this example, consider that UE 1C 352 is being paged. In step 510, UE 1C 352 generates and sends paging response signal 512 to BS 3A 332, which receives the paging response signal in step 514.

The operations, described with respect to steps 432, 434, 436, 438, 440, 442, 444, 448, 450, 454, 456, 460, 462, 466, 468, 482, 486, 488, 502, 506, 508, are repeated multiple times. In addition, DRX setting corresponding to one or more regions may be, and sometimes are, updated, in accordance with the stored paging parameters settings schedule corresponding to the region (402, 404, 406), e.g., with steps/signals 408-442 being implemented, as needed, to update DRX setting values for one or more regions for a new time interval within the schedule.

The base stations in system 300 including BS 1A 324, BS 2A 328 and BS 3A 332 are performing measurements, monitoring performance, receiving reports from UEs being serviced, calculating key performance indicator (KPI) values, and generating reports, which are being sent to performance evaluator server 316, e.g., a network performance evaluator, on an ongoing basis. The generated reports from the base stations include traffic demand information, paging related information and other network performance information. In step 476 BS 1A 324 generates and sends BS 1A reports 478 to performance evaluator server 316, and in step 480 the performance evaluator server 316 receives the BS 1A reports 478 and recovers the communicated information. In step 496 BS 2A 328 generates and sends BS 2A reports 498 to performance evaluator server 316, and in step 500 the performance evaluator server 316 receives the BS 2A reports 498 and recovers the communicated information. In step 516 BS 3A 332 generates and sends BS 3A reports 518 to performance evaluator server 316, and in step 520 the performance evaluator server 316 receives the BS 3A reports 518 and recovers the communicated information.

In step 522 performance evaluator server 316 processes and aggregates information received from base station reports to generate network performance report 524 and sends network performance report 524 to analytics server 318. In some embodiments, the network performance report 524 includes multiple sets of information, each set of information corresponding to a paging region and time interval, e.g., a first set of information corresponding to paging region 1 and time interval 1, a second set of information corresponding to paging region 1 and time interval 2, a third set of information corresponding to paging region 1 and time interval 3, a fourth set of information corresponding to paging region 1 and time interval 4, a fifth set of information corresponding to paging region 2 and time interval 1, a sixth set of information corresponding to paging region 2 and time interval 2, a seventh set of information corresponding to paging region 2 and time interval 3, an eight set of information corresponding to paging region 2 and time interval 4, a ninth set of information corresponding to paging region 3 and time interval 1, a tenth set of information corresponding to paging region 3 and time interval 2, a eleventh set of information corresponding to paging region 3 and time interval 3, and a twelfth set of information corresponding to paging region 2 and time interval 4.

In step 526, analytics server 318 receives the network performance report 524 and recovers the communicated information. In step 528 the analytics server 318 analyzes the received information/statistics for each paging region for each time interval. In step 529, the analytics server 318, based on the analysis results of step 528, generates recommendation DRX information 532, e.g., a DRX settings schedule (e.g., a drx-onDuration Timer value and a drx-InactivityTimer value corresponding to each of one or more time intervals), for each paging region. In step 530 the analytics server 318 sends the recommended DRX information (a DRX settings schedule) for each paging region to the OSS 314. In step 534 the OSS 314 receives the recommended DRX information 532, e.g., information including a DRX settings schedule for each paging region (364, 366, 368) and recovers the communicated information.

In step 536 OSS 314 generates and sends message 538, communicating updated DRX information for region 1, e.g., an updated paging parameters schedule (an updated DRX settings schedule) to be implemented by base stations in paging region 1, to the base stations (BS 1A 324, . . . , BS 1N 326) in region 1. In step 540 BS 1A 324 receives the updated DRX information (region 1) 538 and recovers the communicated information.

In step 542 OSS 314 generates and sends message 544, communicating updated DRX information for region 2, e.g., an updated paging parameters schedule (an updated DRX settings schedule) to be implemented by base stations in paging region 2, to the base stations (BS 2A 328, . . . , BS 2N 330) in region 2. In step 546 BS 2A 328 receives the updated DRX information (region 2) 544 and recovers the communicated information.

In step 548 OSS 314 generates and sends message 550, communicating updated DRX information for region 3, e.g., an updated paging parameters schedule (an updated DRX settings schedule) to be implemented by base stations in paging region 3, to the base stations (BS 3A 332, . . . , BS 3N 334) in region 3. In step 551 BS 3A 332 receives the updated DRX information (region 3) 550 and recovers the communicated information.

In step 562 BS 1A 324 stores the updated DRX information communicated in received message 538, e.g. updated DRX settings/schedule information, for region 1. The updated DRX information is, e.g., an updated paging parameters schedule to be implemented by BS1A 324, said updated paging parameters schedule including a set of DRX parameter values (e.g., a drx-onDuration Timer value and a drx-InactivityTimer value) corresponding to each of one or more time intervals.

In step 564 BS 2A 328 stores the updated DRX information communicated in received message 544, e.g. updated DRX settings/schedule information, for region 2. The updated DRX information is, e.g., an updated paging parameters schedule to be implemented by BS 2A 328, said updated paging parameters schedule including a set of DRX parameter values (e.g., a drx-onDuration Timer value and a drx-InactivityTimer value) corresponding to each of one or more time intervals.

In step 566 BS 3A 332 stores the updated DRX information communicated in received message 550, e.g. updated DRX settings/schedule information, for region 3. The updated DRX information is, e.g., an updated paging parameters schedule to be implemented by BS 3A 332, said updated paging parameters schedule including a set of DRX parameter values (e.g., a drx-onDuration Timer value and a drx-InactivityTimer value) corresponding to each of one or more time intervals.

In step 468 BS 1A 324 generates and sends signals 570, e.g., broadcast signals, communicating DRX setting information (e.g., information indicating a drx-onDuration Timer value and a drx-InactivityTimer value) being implemented by BS 1A 324 for a time interval in accordance with the paging parameters schedule being implemented by BS 1A 324. In step 572 UE 1A 336 receives the signals 570, communicating the DRX setting information, determines the DRX settings information (e.g., drx-onDuration Timer value and drx-InactivityTimer value), and configures to operate using the communicated DRX settings. In step 574 UE NA 338 receives the signals 570, communicating the DRX setting information, determines the DRX settings information (e.g., drx-onDuration Timer value and drx-InactivityTimer value), and configures to operate using the communicated DRX settings.

In step 576 BS 2A 328 generates and sends signals 578, e.g., broadcast signals, communicating DRX setting information (e.g., information indicating a drx-onDuration Timer value and a drx-InactivityTimer value) being implemented by BS 2A 328 for a time interval in accordance with the paging parameters schedule being implemented by BS 2A 328. In step 580 UE 1B 344 receives the signals 578, communicating the DRX setting information, determines the DRX settings information (e.g., drx-onDuration Timer value and drx-InactivityTimer value), and configures to operate using the communicated DRX settings. In step 582 UE NB 346 receives the signals 578, communicating the DRX setting information, determines the DRX settings information (e.g., drx-onDuration Timer value and drx-InactivityTimer value), and configures to operate using the communicated DRX settings.

In step 584 BS 3A 332 generates and sends signals 586, e.g., broadcast signals, communicating DRX setting information (e.g., information indicating a drx-onDuration Timer value and a drx-InactivityTimer value) being implemented by BS 3A 332 for a time interval in accordance with the paging parameters schedule being implemented by BS 3A 332. In step 588 UE 1C 352 receives the signals 586, communicating the DRX setting information, determines the DRX settings information (e.g., drx-onDuration Timer value and drx-InactivityTimer value), and configures to operate using the communicated DRX settings. In step 590 UE NC 354 receives the signals 586, communicating the DRX setting information, determines the DRX settings information (e.g., drx-onDuration Timer value and drx-InactivityTimer value), and configures to operate using the communicated DRX settings.

In step 592 UE 1A 336 is operated to listen for pages, respond to pages, and sleep IAW the configured DRX settings from step 572. In step 594 UE NA 338 is operated to listen for pages, respond to pages, and sleep IAW the configured DRX settings from step 574. In step 596 UE 1B 334 is operated to listen for pages, respond to pages, and sleep IAW the configured DRX settings from step 580. In step 598 UE NB 346 is operated to listen for pages, respond to pages, and sleep IAW the configured DRX settings from step 582. In step 600 UE 1C 352 is operated to listen for pages, respond to pages, and sleep IAW the configured DRX settings from step 588. In step 602 UE NC 354 is operated to listen for pages, respond to pages, and sleep IAW the configured DRX settings from step 590.

In step 604 core 302 generates and sends paging message 606 to each of the base stations in paging region 1 364, said message 606 indicating paging broadcasts for region 1, e.g., a list of UEs to be paged by BSs in paging region 1. In step 608 BS 1A 324 receives paging message 606 and recovers the communicated information, identifying the UEs to be paged by BS 1A 324.

In step 610 core 302 generates and sends paging message 612 to each of the base stations in paging region 2 366, said message 612 indicating paging broadcasts for region 2, e.g., a list of UEs to be paged by BSs in paging region 2. In step 614 BS 2A 328 receives paging message 612 and recovers the communicated information, identifying the UEs to be paged by BS 2A 328.

In step 616 core 302 generates and sends paging message 618 to each of the base stations in paging region 3 368, said message 618 indicating paging broadcasts for region 3, e.g., a list of UEs to be paged by BSs in paging region 3. In step 620 BS 3A 332 receives paging message 618 and recovers the communicated information, identifying the UEs to be paged by BS 3A 332.

In step 622 BS 1A 324 generates and transmits paging signals 624, to page UEs identified in message 608, during DRX on times. In steps 626 and 628 UEs (UE 1A 336, UE NA 338), respectively, monitor for paging signals during DRX on times, receive paging signals 624, and determine whether or not the UE is being paged. In this example, consider that UE 1A 336 is being paged. In step 630, UE 1A 336 generates and sends paging response signal 632 to BS 1A 324, which receives the paging response signal in step 634.

In step 642 BS 2A 328 generates and transmits paging signals 644, to page UEs identified in message 612, during DRX on times. In steps 646 and 648 UEs (UE 1B 344, UE NB 346), respectively, monitor for paging signals during DRX on times, receive paging signals 644, and determine whether or not the UE is being paged. In this example, consider that UE 1B 344 is being paged. In step 650, UE 1B 346 generates and sends paging response signal 652 to BS 2A 328, which receives the paging response signal in step 654.

In step 662 BS 3A 332 generates and transmits paging signals 664, to page UEs identified in message 618, during DRX on times. In steps 666 and 668 UEs (UE 1C 352, UE NC 354), respectively, monitor for paging signals during DRX on times, receive paging signals 664, and determine whether or not the UE is being paged. In this example, consider that UE 1C 352 is being paged. In step 670, UE 1C 352 generates and sends paging response signal 672 to BS 3A 332, which receives the paging response signal in step 674.

The operations, described with respect to steps 592, 594, 596, 598, 600, 602, 604, 608, 610, 614, 616, 620, 622, 626, 628, 642, 646, 648, 662, 666, 668, are repeated multiple times. In addition, DRX setting corresponding to one or more regions may be, and sometimes are, updated, in accordance with the stored paging parameters settings schedule corresponding to the region (562, 564, 566), e.g., with steps/signals 468-590 being implemented, as needed, to update DRX setting values for one or more regions for a new time interval within the schedule.

The base stations in system 300 including BS 1A 324, BS 2A 328 and BS 3A 332 are performing measurements, monitoring performance, receiving reports from UEs being serviced, calculating key performance indicator (KPI) values, and generating reports, which are being sent to performance evaluator server 316, e.g., a network performance evaluator, on an ongoing basis. The generated reports from the base stations include traffic demand information, paging related information and other network performance information. In step 636 BS 1A 324 generates and sends BS 1A reports 638 to performance evaluator server 316, and in step 640 the performance evaluator server 316 receives the BS 1A reports 638 and recovers the communicated information. In step 656 BS 2A 328 generates and sends BS 2A reports 658 to performance evaluator server 316, and in step 660 the performance evaluator server 316 receives the BS 2A reports 658 and recovers the communicated information. In step 676 BS 3A 332 generates and sends BS 3A reports 678 to performance evaluator server 316, and in step 680 the performance evaluator server 316 receives the BS 3A reports 678 and recovers the communicated information.

In step 682 performance evaluator server 316 processes and aggregates information received from base station reports to generate network performance report 684 and sends network performance report 684 to analytics server 318. In some embodiments, the network performance report 684 includes multiple sets of information, each set of information corresponding to a paging region and time interval, e.g., a first set of information corresponding to paging region 1 and time interval 1, a second set of information corresponding to paging region 1 and time interval 2, a third set of information corresponding to paging region 1 and time interval 3, a fourth set of information corresponding to paging region 1 and time interval 4, a fifth set of information corresponding to paging region 2 and time interval 1, a sixth set of information corresponding to paging region 2 and time interval 2, a seventh set of information corresponding to paging region 2 and time interval 3, an eight set of information corresponding to paging region 2 and time interval 4, a ninth set of information corresponding to paging region 3 and time interval 1, a tenth set of information corresponding to paging region 3 and time interval 2, a eleventh set of information corresponding to paging region 3 and time interval 3, and a twelfth set of information corresponding to paging region 2 and time interval 4.

In step 686, analytics server 318 receives the network performance report 684 and recovers the communicated information. In step 688 the analytics server 318 analyzes the received information/statistics for each paging region for each time interval. In step 689, the analytics server 318, based on the analysis results of step 688, generates recommendation DRX information 692, e.g., a DRX settings schedule (e.g., a drx-onDuration Timer value and a drx-InactivityTimer value corresponding to each of one or more time intervals), for each paging region. In step 690 the analytics server 318 sends the recommended DRX information (a DRX settings schedule) for each paging region to the OSS 314. In step 694 the OSS 314 receives the recommended DRX information 692, e.g., information including a DRX settings schedule for each paging region (364, 366, 368) and recovers the communicated information.

In step 696 OSS 314 generates and sends message 698, communicating updated DRX information for region 1, e.g., an updated paging parameters schedule (an updated DRX settings schedule) to be implemented by base stations in paging region 1, to the base stations (BS 1A 324, . . . , BS 1N 326) in region 1. In step 702 BS 1A 324 receives the updated DRX information (region 1) 698 and recovers the communicated information.

In step 702 OSS 314 generates and sends message 704, communicating updated DRX information for region 2, e.g., an updated paging parameters schedule (an updated DRX settings schedule) to be implemented by base stations in paging region 2, to the base stations (BS 2A 328, . . . , BS 2N 330) in region 2. In step 706 BS 2A 328 receives the updated DRX information (region 2) 704 and recovers the communicated information.

In step 708 OSS 314 generates and sends message 710, communicating updated DRX information for region 3, e.g., an updated paging parameters schedule (an updated DRX settings schedule) to be implemented by base stations in paging region 3, to the base stations (BS 3A 332, . . . , BS 3N 334) in region 3. In step 712 BS 3A 332 receives the updated DRX information (region 3) 710 and recovers the communicated information.

Operation proceeds back to steps 562, 564 and 566 with the updated DRX information received in steps 700, 706 and 712 being stored by the base stations (324, 328, 332), respectively, and the process of signaling diagram part B 403 continues. Thus, the steps of Part B 403, including dynamically implementing new (updated) paging parameters schedules, e.g., with different paging parameter schedules for different regions, can be repeated following updates of DRX information based on recently analyzed network performance data. This approach facilitates rapid dynamic adjustments to paging parameter settings (drx-onDuration Timer value and drx-Inactivity Timer value) on a time interval and per region basis, e.g., to adjust to network conditions, and reduce power consumption by the UEs while satisfying the paging demands of the network.

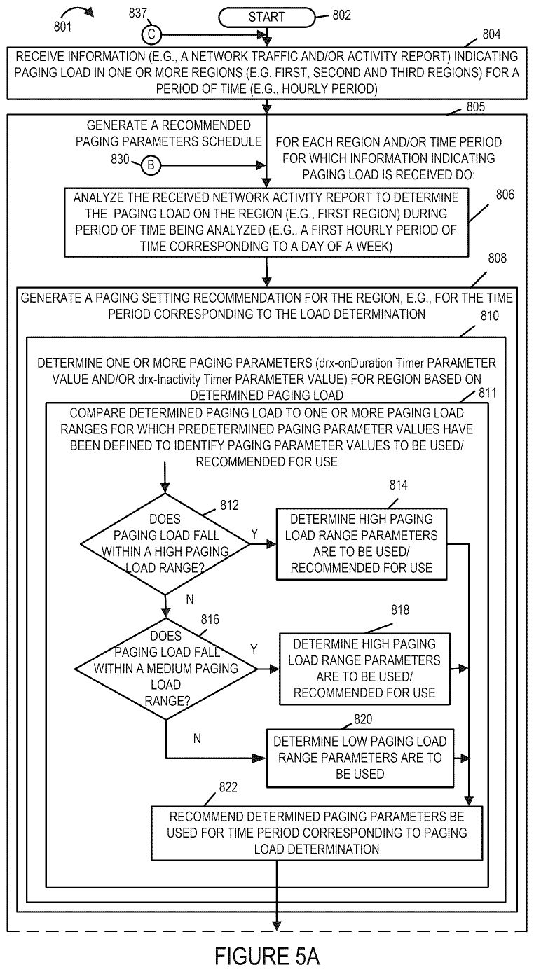

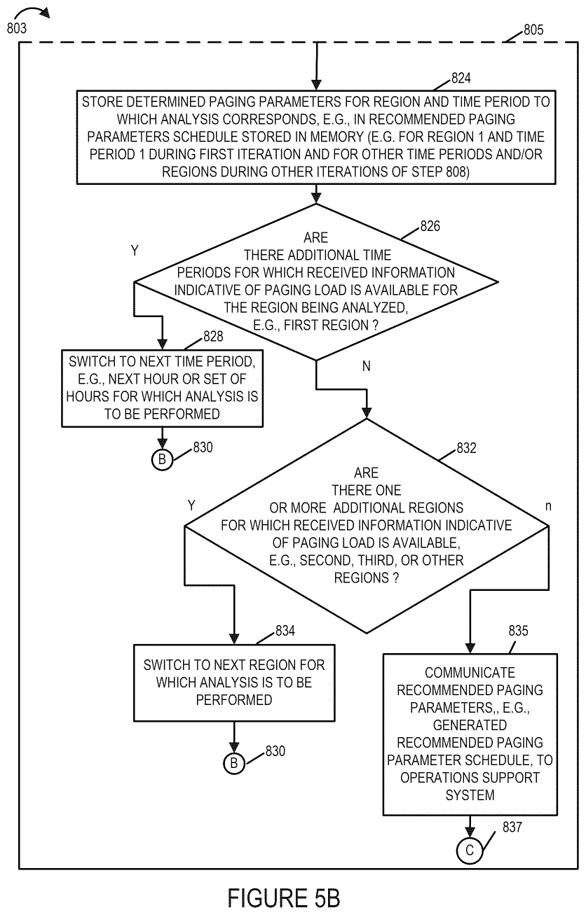

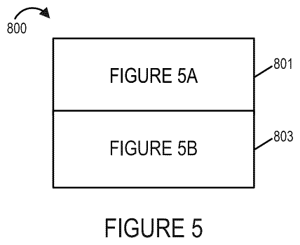

In various embodiments, the operations of steps 526, 528, 529, and 530 of Part A 401 of FIG. 4A and/or the operations of steps 686, 688, 689, and 690 of Part B 403 of FIG. 4B, performed by analytics server 318, are implemented by the method of flowchart 800 of FIG. 5.

FIG. 5 is a diagram representing a flowchart 800. FIG. 5 shows how the first portion 801 of the flowchart 800 shown FIG. 5A and the second part of the flowchart 803 shown in FIG. 5B are to be combined to form the complete flowchart 800. The flowchart 800 shows the steps of a method implemented by an analytics server 318, which receives and processes network information, e.g., a network traffic and/or activity report, to generate paging parameter recommendations for one or more regions, e.g., tracking regions, in which paging is performed. Flowchart 800 can be used to implement the receiving step 526, analyzing step 528, paging parameter recommendation generation step 529 and recommended DRX information settings and/or schedule communication step 530.

FIG. 5A shows the first part 801 of the method 800 with operation beginning in step 802 with the analytics server 318 being powered on and ready to receive and process network information, e.g., traffic information, key performance information and/or paging information, indicative of a paging load on one or more regions, e.g., tracking regions, in which paging is controlled on a per region basis. Operation proceeds from start step 802 to step 804 in which network information is received. Step 804 corresponds to step 526 of FIG. 4 in some embodiments with the network information being received by the analytics server 318 in the form of a report, e.g., a network traffic and/or activity report, providing information indicating the paging load in ore or more regions, e.g., regions for which paging parameters are to be determined and recommended, e.g., to the operational support system 314 used to control which paging parameters are used in the various regions of the system at any given time. While the received network information can include information about the actual number of pages which are sent in one or more regions during the time period or periods to which a received report corresponds, it can, and sometimes does, include information about network traffic in the various regions with the network traffic load in a region being indicative of the amount of paging in a region with a high traffic load being indicative of a corresponding high paging load in the region with the high traffic load. The received information can be information extending over a long period of time, e.g., a day, multiple days, or a week with the included information providing details on a finer time scale, e.g., on an hourly basis or per minute basis.

With a network traffic and/or activity report having been received in step 804 operation proceeds to analysis and recommendation generation step 805 in which paging parameter recommendations are generated on a per region and/or per time period basis and incorporated into a paging parameter schedule which includes recommended paging parameters for one or more regions and one or more time periods. The time periods for which paging recommendations are made may correspond to shorter intervals than the overall duration for which the received information indicating paging load corresponds. For example, the network traffic and/or activity report received in step 804, may correspond to and include information relating to, a week of network traffic. For analysis purposes the network information can be considered and processed on an hourly or some other basis with paging parameter recommendations being generated for each region on the basis of relatively shorter time intervals, e.g., hourly or multi-hour time intervals. While the paging parameter recommendations may be generated on an hourly time interval basis in some embodiments, unless the traffic load in a region changes significantly, e.g., from one load category to another, e.g., from a high to a low or medium amount, the recommended paging parameters are likely to remain the same for an extended period of time in a region. While the generated paging parameter schedule can be on an hourly bases for a period of time such as a week with a set of paging parameter recommendations being provided for each day of the week in some embodiments with parameters being recommended, e.g., on a hourly basis, the time periods for which recommendations are performed vary in size and need not be of uniform size, e.g., some time periods for which paging parameters are generated may be longer than others. For example, during the night paging parameters may be suggested on a two or 3 hour basis, while during the day with more frequent changes in network traffic load due to human activity, hourly paging parameters may be generated and provided as part of a schedule.

Traffic analysis and paging parameter recommendation step 805 in some embodiments includes generating a recommended paging parameter schedule. In some embodiments generating a paging parameter schedule includes performing steps 806 through 834 for each region and/or time period for which a paging recommendation is to be generated based on the received information and included in the schedule being generated. In some embodiments each hour of a day of a week is treated as a different time period for paging parameter recommendation generation purposes. In some embodiments each region for which a paging parameter recommendation is generated corresponds to a tracking area region in which paging is performed using the same set of paging parameters. In the simplest case the generated paging parameter may correspond to a single region and single time period. However, in many cases the paging parameter schedule includes recommendations for multiple time periods, e.g., hourly time periods for each day of a week, and multiple different regions.

In step 806, shown in FIG. 5A, the information included in the received network activity report is used to determine the paging load on the region for which a parameter recommendation is being made during the time period for which the recommendation is being made. For example, based on the information in the received network traffic and/or activity report the paging load is determined, e.g., estimated, as corresponding to one of a plurality of predetermined levels. In some embodiment the paging load is determined based on network data traffic load in the region with the paging load being a function of or predicted based on the traffic load since the paging load normally corresponds to the overall traffic load in a region, e.g., a high data traffic load is normally indicative of a high paging load, a medium traffic load is indicative of a medium paging load and a low traffic load in a region is indicative of a low paging load. In other embodiments the paging load is determined based on information in a report indicating the actual number of pages or actual detected paging load in a region for which information is included in the received report.

With the paging load on the region for which a parameter recommendation is to be generated having been determined for a time period in step 806, the paging load information is used to generate a paging parameter recommendation for a future corresponding time period. Operation proceeds from step 806 to step 808 in which a paging setting recommendation for the region and time period is generated. For example, in step 808 a paging parameter recommendation is generated based on the determined paging load for a future day and hour period corresponding to the day and hour period for which the paging load was determined. In some embodiments step 808 includes step 810 in which one or more paging parameters, e.g., drx-onDuration Timer and/or drx-Inactivity Timer parameter values, are determined based on the paging load determined for the region and corresponding time period for which the parameters are being generated.

Step 810 in some embodiments includes load to predetermined parameter mapping step 811, in which the determined paging load is compared to one or more paging load ranges to determine which paging load range the determined paging load corresponds to and then predetermined paging parameter values corresponding to the determined paging load range are selected, e.g., determined, to be the paging parameters to be used and/or recommended for the region and time period for which the paging recommendation is being made.

Setpe 810 in some embodiments includes comparison and paging parameter determination step 811 which includes sub-steps 812-822. In step 812 the determined load is compared to a high paging load range to determine if the determined paging load for the region falls within the predetermined high paging load range. If in step 812 it is determined that the paging load for the region falls in the high paging load range, operation proceeds to step 814 in which it is determined that high paging load range parameters should be used and/or recommended for the region and time period to which the determined paging load corresponds. The high paging load range parameters may, and sometimes do, include predetermined drx-onDuration Timer and drx-Inactivity Timer parameter values which have been selected and stored as paging parameter values which are suitable for regions subject to a high paging load. The drx-onDruation Timer and drx-Inactivity Timer for the high paging load corresponds to a longer drx-on duration and a longer drx-Inactivity duration than the parameters determined for lower paging loads, e.g., medium and low paging load ranges. Thus, determination of a high paging load maps to paging parameters which have been stored and which were previously selected or determined as being suitable for use in regions subject to high paging loads.

However, if in step 812, it is determined that the paging load for the region does not fall within the predetermined high paging load range, operation proceeds to step 816 in which the determined paging load is compared to a medium paging load range.

If in step 816, it is determined that the paging load for the region falls in the medium paging load range operation proceeds to step 818 in which it is determined that medium paging load range parameters should be used and/or recommended for the region and time period to which the determined paging load corresponds. The medium paging load range parameters may, and sometimes do. include predetermined drx-onDuration Timer and drx-Inactivity Timer parameter values which have been selected and stored as paging parameter values which are suitable for regions subject to a medium paging load. Thus, determination of a medium paging load maps to paging parameters which have been stored and which were previously selected or determined as being suitable for use in regions subject to medium paging loads. The drx-onDuration Timer and drx-Inactivity Timer parameter values for the medium paging load have, in some embodiments, a shorter drx-on duration and shorter drx-Inactivity period than high paging load parameters.

In the exemplary embodiment three paging load ranges are considered, e.g., high, medium and low paying load ranges are considered with reach range having corresponding predetermined paging parameters to be recommended/used in the case of a paging load corresponding to the predetermined range. In other embodiments a larger number of ranges may be considered. Different ranges may have the same drx-onDuration Timer parameter value but a different drx-Inactivity Timer parameter value associated with it while in other cases two ranges may have the same drx-Inactivity Timer parameter value associated with it but different drx-onDuration Timer parameter values.

In the FIG. 5 example, if the determined paging load range does not correspond to the high or medium paging load ranges, then it must correspond to the low paging load range since only 3 paging load ranges are supported in the FIG. 5 example. Thus, a no determination in step 816 represents a determination that the determined paging load for the region, for which a recommendation is being generated, corresponds to a determination that the determined load corresponds to the low paging load range. Operation proceeds from step 816, in the case of a no determination indicating a low paging load, to step 820 in which load paging load parameters are determined to be used given that the determined paging load corresponds to the low range. The predetermined low paging load parameters include a drx-onDuration Timer parameter value and a drx-Inactivity Timer parameter value which correspond to a shorter drx-on duration and shorter drx-Inactivity duration than the parameter values used for high or medium paging loads.

With the paging parameters to be used having been determined in one of steps 814, 818 or 820, operation proceeds to step 822, in which the determined paging parameters are recommended as the paging parameters to be used for a future time, e.g., a future day and time of a week, corresponding to the day and time of week for which the paging load was determined. For example, if the paging load was determined for region 1, based on a Monday 5-6 pm load, the determined paging parameters are recommended for Monday 5-6 pm time periods which may be encountered in the future.

Operation proceeds from step 822 to step 824 shown in FIG. 5B which shows additional steps which are included, in some embodiments, in step 805. In step 824 the determined paging parameters, e.g., recommended paging parameters for the region and time period to which the analysis corresponds, are stored in a recommended paging parameters schedule which may be included in memory of the analytics server 318. The schedule will include a recommendation for a single region and time period, e.g., region 1 and time period 1, after the first iteration of step 805 but as step 805 is performed for different time periods and/or regions the proposed parameter schedule will be populated with additional paging parameters, e.g., paging parameters recommended for first second and third regions and for different time periods at each of said first second and third regions. Thus as the analyzing of the network information indicative of paging load progresses, a complete schedule of recommended paging parameters may be, and sometimes is, generated for a multi-day period of time for multiple regions.

Steps 826 through 832 control analysis iterations based on whether there are additional time periods and/or regions for which paging load information is to be analyzed and paging parameter recommendations made, e.g., given the set of information received in step 804.

Operation proceeds from step 824 to step 826 in which a check is made to determine if there are any additional time periods for which received information indicative of paging load is available for the region being analyzed. If there is information for additional time periods corresponding to the region being analyzed, operation proceeds from step 826 to step 828 in which a switch is made to analyzing the information for the next time period for the region for which the analysis is being performed. For example, during first iteration of step 824 recommended paging parameters for region 1, time period 1 will be stored and then in step 828 the time period will be switched to time period 2 so that recommended paging parameters for region 1, time period 2 will be generated during the next iteration of the analysis and paging parameter recommendation process.

Operation proceeds from step 828 to step 806 via connecting node B 830 so that the analysis for the next time period can be performed and paging parameters for the next time period recommended.

If in step 826 it is determined that there are not additional time periods for which received information indicative of paging load is available for the region being analyzed, e.g., all the time periods have been considered for region 1 and paging parameter recommendations made for each time period, e.g., for which load information is available or for which paging parameters are to be included in the schedule, operation proceeds to step 832.

In step 832 a check is made as to whether there are one or more additional regions for which received information indicating of paging load is available, e.g., second, third or other regions, for which paging parameter recommendations are to be generated.

If in step 832 it is determined that there is an additional region for which a paging parameter recommendation is to be made and there is information available for making the recommendation, operation proceeds to step 834 in which a switch is made to the next region so that analysis can be performed for the next region, e.g., a second region after the paging parameter recommendation(s) were generated for a first region. Operation proceeds from step 834 via connecting node 830 to step 806 so that analysis and recommendation can be generated for the next region for which information is available from the information received in step 804.

If in step 832 it is determined that there are no additional regions for which paging parameter recommendations are to be generated, operation proceeds to step 835, in which the generated paging parameter recommendations, e.g., recommended paging parameter schedule, is communicated to the operations support system 314 so that the recommendations can be used in the system to control one or more base stations and/or UEs to implement paging operations in accordance the per region and time period recommendations. Step 835, in some embodiments, corresponds to paging parameter recommendation communication step 530 of FIG. 4.

Operation is shown proceeding from step 835 via connecting node C 837 to step 804 to show that the analysis and paging parameter recommendation process can be performed on an ongoing basis as new information is received by the analysis server allowing for updated paging parameter recommendations to be made.

By using the described processes paging parameters can be selected and changed based on actual network traffic and/or paging information corresponding to different reasons with the understanding that network traffic loads and/or paging loads tend to occur in a repetitive manner with information about loads during past days/time periods being generally reliable predictors of loads/paging requirements likely to occur during future matching days/time periods to the days/time periods for which information is collected.

The methods allow for paging parameters to be varied over time based on actual collected network loading information and updated as measured loads in paging regions change from the loads experienced in previous time periods.

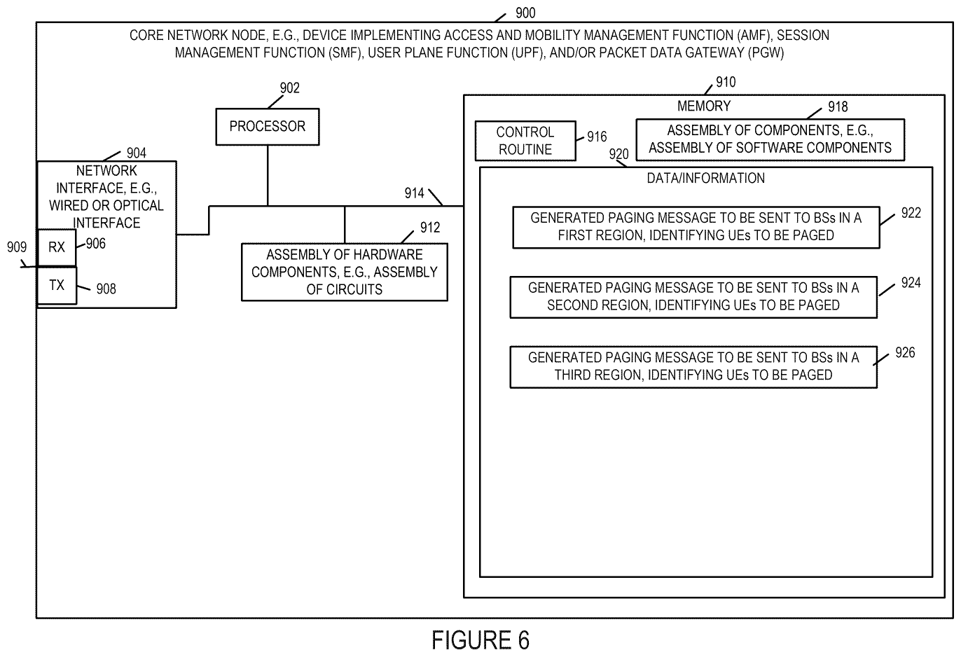

FIG. 6 is a drawing of an exemplary core network node 900, e.g., a device implementing an access and mobility management function (AMF), a session management function (SMF), a user plane function (UPF), and/or a PGW (Packet data gateway), in accordance with an exemplary embodiment. Exemplary core network node 900 is, e.g., core 302 of system 300 of FIG. 3 and/or signaling diagram 400 of FIG. 4.

Core network node 900 includes a processor 902, e.g., a CPU, a network interface 904, memory 910, and assembly of hardware components 912, e.g., an assembly of circuits, coupled together via bus 914 over which the various elements may interchange data and information.

Network interface 904, e.g., a wired or optical interface, includes a receiver (RX) 906, a transmitter (TX) 908 and connector 909 coupled together. Memory 910 includes a control routine 916, an assembly of components 918, e.g., an assembly of software components, and data information 920.

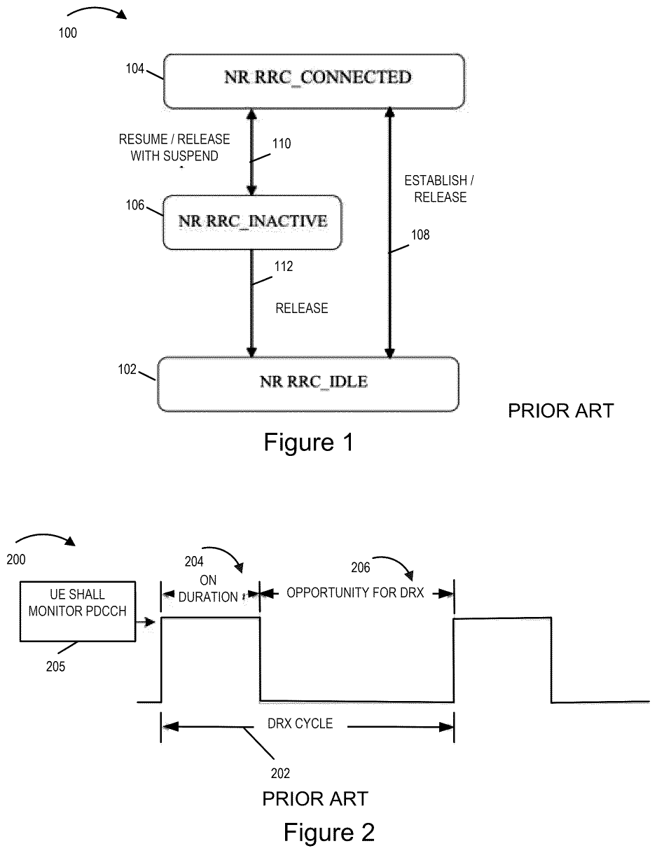

Control routine 916 includes instructions, which when executed by processor 902, control the core network node 900 to implement basic operational functions, e.g., read memory, write to memory, control an interface, load a program, subroutine, or app, etc. Assembly of components 918, e.g., an assembly of software components, e.g., routines, subroutines, applications, etc., includes, e.g., code, e.g., machine executable instructions, which when executed by processor 902, controls the core network node 900 to implement steps of a method, e.g., steps of a method which are performed by core network 302 of system 100 of FIG. 1 and/or of signaling diagram 400 FIG. 4.

Data/information 920 includes a generated paging message 922 to be sent to base stations in a first paging region, said generated paging message 922 identifying UEs to be paged by BSs in the first paging region, a generated paging message 924 to be sent to base stations in a second paging region, said generated paging message 924 identifying UEs to be paged by BSs in the second paging region, and a generated paging message 926 to be sent to base stations in third paging region, said generated paging message 926 identifying UEs to be paged by BSs in the third paging region,

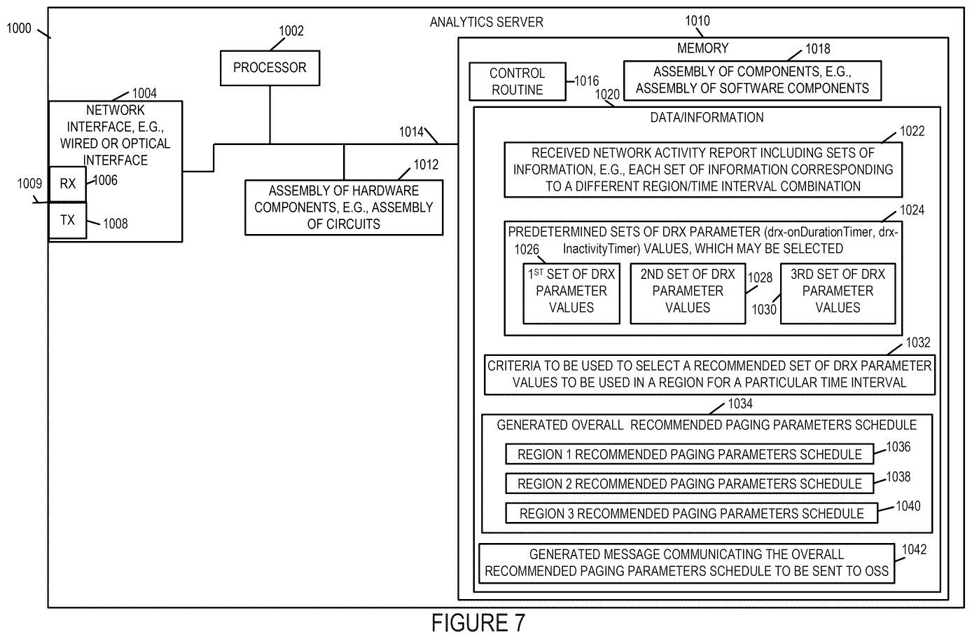

FIG. 7 is a drawing of an exemplary analytics server 1000 in accordance with an exemplary embodiment. Exemplary analytics server 1000 is, e.g., analytics server 318 of system 300 of FIG. 3 and/or signaling diagram 400 of FIG. 4.

Analytics server 1000 includes a processor 1002, e.g., a CPU, a network interface 1004, memory 1010, and an assembly of hardware components 1012, e.g., an assembly of circuits, coupled together via bus 1014 over which the various elements may interchange data and information.

Network interface 1004, e.g., a wired or optical interface, includes a receiver (RX) 1006, a transmitter (TX) 1008 and connector 1009 coupled together. Memory 1010 includes a control routine 1016, an assembly of components 1018, e.g., an assembly of software components, and data information 1020.

Control routine 1016 includes instructions which when executed by processor 1002 control the analytics server 1000 to implement basic operational functions, e.g., read memory, write to memory, control an interface, load a program, subroutine, or app, etc. Assembly of components 1018, e.g., an assembly of software components, e.g., routines, subroutines, applications, etc., includes, e.g., code, e.g., machine executable instructions, which when executed by processor 1002, controls the analytics server 1000 to implement steps of a method, e.g., steps of a method which are performed by analytics server 318 of system 300 of FIG. 3, of signaling diagram 400 FIG. 4, and/or flowchart 800 of FIG. 5.

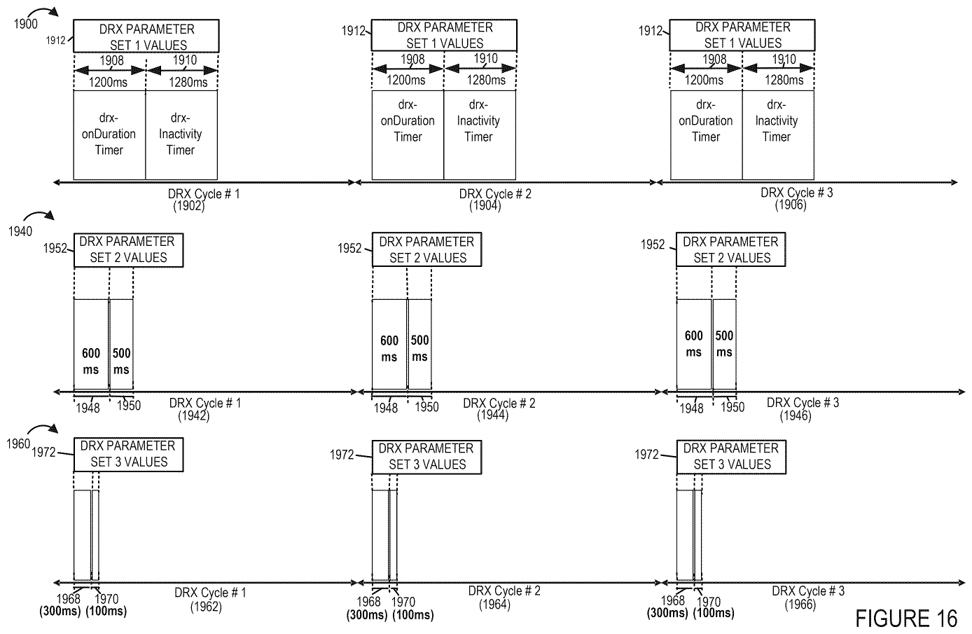

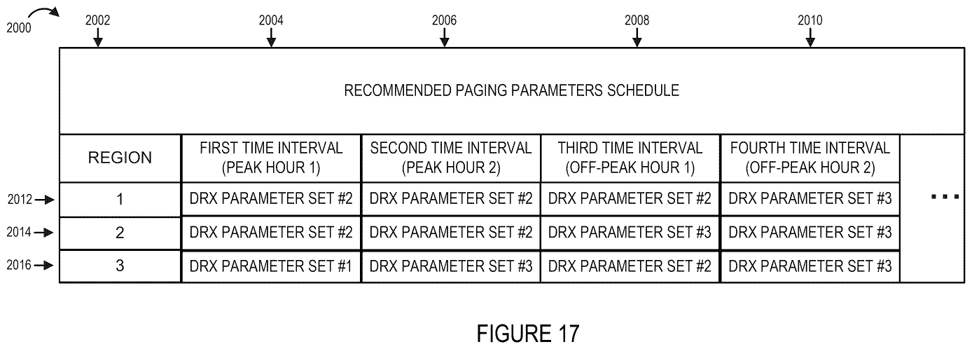

Data/information 1020 includes a received network activity report 1022 including sets of information, e.g., each set of information corresponding to a different region/time interval combination. Exemplary data included in the received network activity report includes, e.g., on a per region/time interval basis: traffic demand, KPI parameters, level of paging activity, number of pages, success rate for pages, information indicating inability to perform pages because of lack of available paging resources, paging success rate, etc. Data/information 1020 further includes predetermined sets 1024 of DRX parameter (drx-onDuration Timer, drx-Inactivity Timer) values, which may be selected as a recommended set of DRX parameters to be used during a time interval in a paging region. The predetermined sets 1024 of DRX parameter values includes a 1st set of DRX parameter values 1026, a 2nd set of DRX parameter values 1028 and a 3rd set of DRX parameter values 1020. FIG. 16 illustrates three exemplary predetermined sets of DRX parameter values. Data/information 1024 further includes criteria 1032 used to select a recommended set of DRX parameter values to be used in a region for a particular time interval. Data/information 1024 further includes a generated overall recommended paging parameters schedule 1034 to be communicated to an OSS including configuration capability for distribution of the included recommended information to the appropriate base stations for each region. FIG. 17 illustrates an exemplary overall recommended paging parameters schedule including recommended paging parameters (e.g., selected sets of DRX parameters) to be used during particular time intervals in each of 3 different regions. Generated overall recommended paging parameters schedule 1034 includes a region 1 recommended paging parameters schedule 1036, which identifies which set of DRX parameter values to use in each of a plurality of time intervals for base stations in region 1, a region 2 recommended paging parameters schedule 1038, which identifies which set of DRX parameter values to use in each of a plurality of time intervals for base stations in region 2, and a region 2 recommended paging parameters schedule 1040, which identifies which set of DRX parameter values to use in each of a plurality of time intervals for base stations in region 2. Data/information 1020 further includes a generated message 10422 communicating the overall recommended paging parameters schedule to be sent to the OSS.

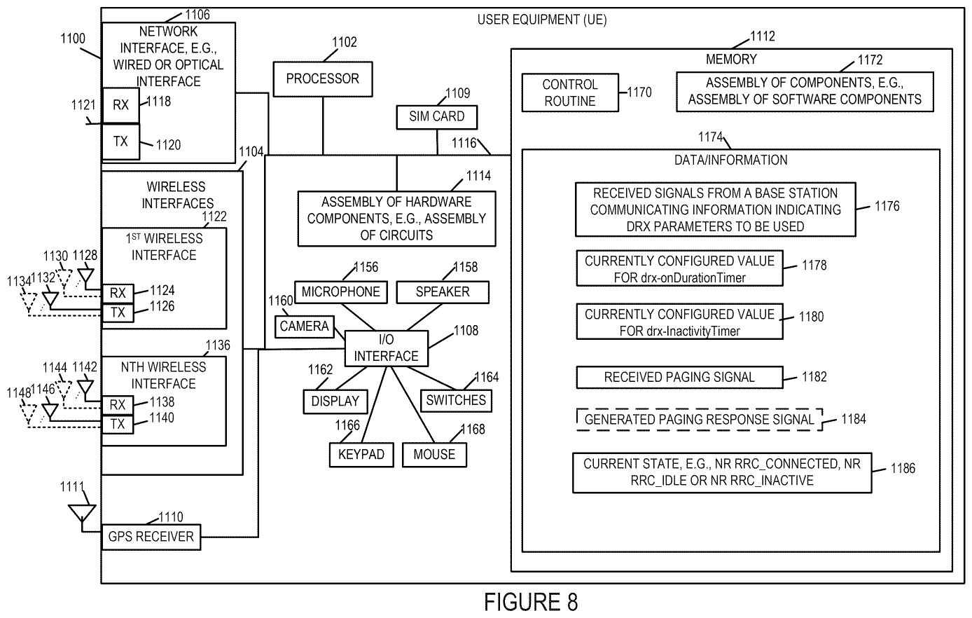

FIG. 8 is a drawing of an exemplary user equipment (UE) 1100 in accordance with an exemplary embodiment. Exemplary UE 1100 is, e.g., any of UEs 336, 338, 340, 342, 344, 346, 348, 350, 352, 354, 356, 358 of system 300 of FIG. 3 and/or signaling diagram 400 of FIG. 4.

Exemplary UE 1100 includes a processor 1102, e.g., a CPU, wireless interfaces 1104, a network interface 1106, an I/O interface 1108, a SIM card 1109, a GPS receiver 1110, memory 1112, and assembly of hardware components 1114, e.g., an assembly of circuits, coupled together via bus 1116 over which the various elements may interchange data and information.

Wireless interfaces 1104 includes a plurality of wireless interfaces (1st wireless interface 1122, . . . , Nth wireless interface 1136). Different wireless interfaces may correspond to different frequencies, different communications bands, different technologies and/or different communications protocols. 1st wireless interface 1122 includes wireless receiver 1124 coupled to one or more receive antennas (1128, . . . ,130) via which the UE 1100 receives wireless signals, e.g., from a base station. 1st wireless interface 1122 includes wireless transmitter 1126 coupled to one or more transmit antennas (1132, . . . , 1134) via which the UE 1100 transmits wireless signals, e.g., to a base station. Nth wireless interface 1136 includes wireless receiver 1138 coupled to one or more receive antennas (1142, . . . , 1144) via which the UE 1100 receives wireless signals. Nth wireless interface 1136 includes wireless transmitter 1140 coupled to one or more transmit antennas (1146, . . . , 1146) via which the UE 1100 transmits wireless signals.

Network interface 1106, e.g., a wired or optical interface, includes receiver 1118, transmitter 1120 and connector 1121 coupled together. Network interface 1106 provides a wired or optical connection interface, which may be used by UE 1100, when stationary and when located at a location in which a wired or optical connection, e.g., cable or fiber link connection, is available.

GPS receiver 1110 is coupled to GPS antenna 1111, via which GPS receiver 1110 receives GPS signals. Based on the received GPS signals, GPS receiver 1110 determines UE 1100 position, e.g., latitude, longitude and latitude, time, and velocity information.

UE 1100 further includes a plurality of I/O devices (microphone 1156, speaker 1158, camera 1160, display 1162, switches 1164, keypad 1166 and mouse 1168) coupled to I/O interface 1108, via which the various I/O devices may communicate with each other and/or external devices, receive input from a user of UE 1100 and/or output data/information to a user of UE 1100.

Memory 1112 includes a control routine 1170, an assembly of components 1172, e.g., an assembly of software components, and data/information 1174. Control routine 1170 includes instructions which when executed by processor 1102 control the end user device 1100 to implement basic operational functions, e.g., read memory, write to memory, control an interface, load a program, subroutine, or app, etc. Assembly of components 1172, e.g., an assembly of software components, e.g., routines, subroutines, applications, etc., includes, e.g., code, e.g., machine executable instructions, which when executed by processor 1102, controls the UE 1100 to implement steps of a method, e.g., steps of a method which are performed by any of the UEs of system 300 of FIG. 3 and/or of signaling diagram 400 FIG. 4.

Data/information 1174 includes received signals 1176, from a base station communicating information indicating DRX parameters to be used by UE 1100 for communication with the base station, a currently configured value for drx-onDuration timer 1178, a currently configured value for drx-Inactivity Timer 1180, a received paging signal 1182, a generated paging response signal 1184, and information 1186 indicating a current state of the UE 1100, e.g., NR RRC_ CONNECTED, NR RRC_IDLE, or NR RRC_INACTIVE.

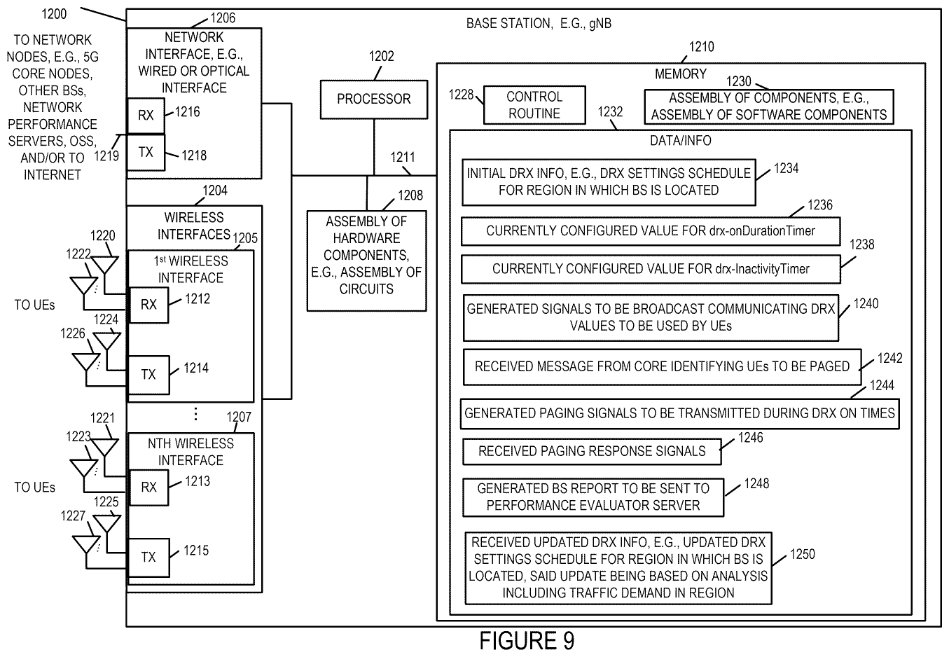

FIG. 9 is a drawing of an exemplary base station 1200, e.g., a gNB, in accordance with an exemplary embodiment. Exemplary base station 1200 is, e.g., any of base stations 324, 326, 328, 330, 332, 334 of system 300 of FIG. 3 and/or signaling diagram 400 of FIG. 4.

Base station 1200 includes a processor 1302, e.g., a CPU, wireless interfaces 1204, a network interface 1206, an assembly of hardware components 1208, e.g., an assembly of circuits, and memory 1210 coupled together via bus 1211 over which the various elements may interchange data and information.

Wireless interfaces 1204 includes a plurality of wireless interfaces (1st wireless interface 1205, . . . , Nth wireless interface 1207). Different wireless interfaces may correspond to different frequencies, different communications bands, different technologies and/or different communications protocols. 1st wireless interface 1205 includes wireless receiver 1212 coupled to one or more receive antennas (1220, . . . , 1222) via which the base station 1200 receives wireless signals, e.g., from UEs. 1st wireless interface 1205 includes wireless transmitter 1214 coupled to one or more transmit antennas (1224, . . . , 1226) via which the base station 1200 transmits wireless signals, e.g., to UEs. Nth wireless interface 1207 includes wireless receiver 1213 coupled to one or more receive antennas (1221, . . . , 1223) via which the base station 1200 receives wireless signals, e.g., from UEs. Nth wireless interface 1207 includes wireless transmitter 1215 coupled to one or more transmit antennas (1225, . . . , 1227) via which the base station 1200 transmits wireless signals, e.g., to UEs.

Network interface 1206, e.g., a wired or optical interface, includes receiver 1216, transmitter 1218 and connector 1219 coupled together. Network interface 1206 couples base station 1200 to network nodes, e.g., 5G core nodes, other base stations, network performance evaluator servers, analytics servers, OSS devices, and/or the Internet.

Memory 1210 includes a control routine 1228, an assembly of components 1230, e.g., an assembly of software components, and data information 1232. Control routine 1228 includes instructions which when executed by processor 1202 control the base station 1200 to implement basic operational functions, e.g., read memory, write to memory, control an interface, load a program, subroutine, or app, etc. Assembly of components 1230, e.g., an assembly of software components, e.g., routines, subroutines, applications, etc., includes, e.g., code, e.g., machine executable instructions, which when executed by processor 1202, controls the base station 1200 to implement steps of a method, e.g., steps of a method which are performed by any of the base station of system 300 of FIG. 3 and/or by any of the base stations 324, 328, 332 of signaling diagram 400 FIG. 4.

Data/information 1232 includes initial DRX information 1234, e.g., an initial DRX setting schedule for region 1 in which base station 1200 is located, a currently configured value for drx-onDurationTimer 1236, a currently configured value for drc-Inactivity Timer 1238, generated signals 1240 to be broadcast communicating information indicating DRX values to used by UEs, a received message 1242 for a core network node identifying UEs to be paged, generated paging signals 1244 to be transmitted during DRX on times, received paging response signals 1246, a generated base station report 1248 to be sent to a performance evaluator server, said report including, e.g., traffic demand information, paging related information, and KPI information. Data/information 1232 further includes received updated DRX information 1250, e.g., an updated DRX setting schedule for the region in which BS 1200 is located, said update being based on analysis including taking into consideration the traffic demand in the region during each of a plurality of different time intervals.

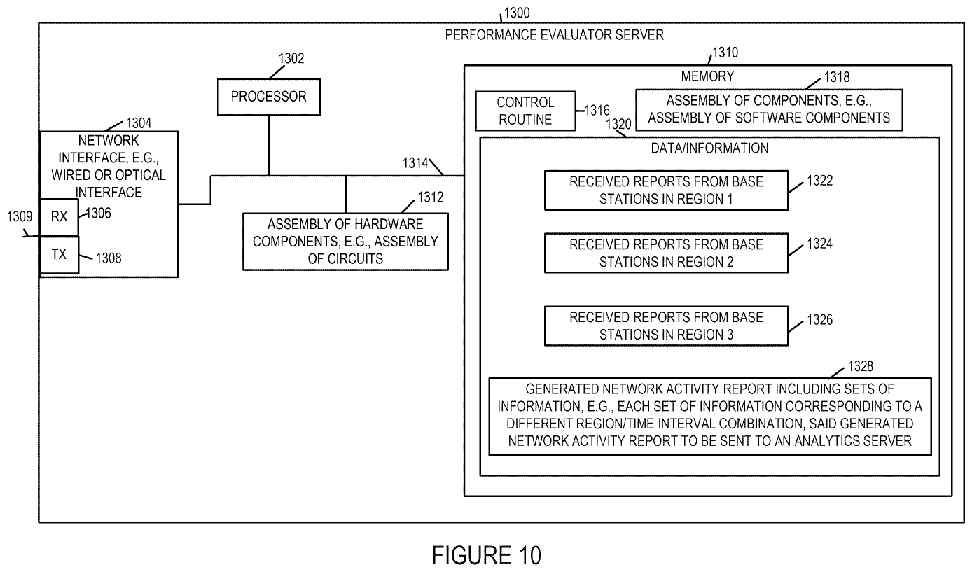

FIG. 10 is a drawing of an exemplary performance evaluator server 1300, e.g., a network performance evaluator server, in accordance with an exemplary embodiment. Exemplary performance evaluator server 1300 is, e.g., performance evaluator server 316 of system 300 of FIG. 3 and/or signaling diagram 400 of FIG. 4.

Performance evaluator server 1300 includes a processor 1302, e.g., a CPU, a network interface 1304, memory 1310, and assembly of hardware components 1312, e.g., an assembly of circuits, coupled together via bus 1314 over which the various elements may interchange data and information.

Network interface 1304, e.g., a wired or optical interface, includes a receiver (RX) 1306, a transmitter (TX) 1308 and connector 1309 coupled together. Memory 1310 includes a control routine 1316, an assembly of components 1318, e.g., an assembly of software components, and data information 1320.

Control routine 1316 includes instructions which when executed by processor 1302 control the performance evaluator server 1300 to implement basic operational functions, e.g., read memory, write to memory, control an interface, load a program, subroutine, or app, etc. Assembly of components 1318, e.g., an assembly of software components, e.g., routines, subroutines, applications, etc., includes, e.g., code, e.g., machine executable instructions, which when executed by processor 1302, controls the performance evaluator server 1300 to implement steps of a method, e.g., steps of a method which are performed by performance evaluator server 316 of system 300 of FIG. 3 and/or of signaling diagram 400 FIG. 4.

Data/information 1320 includes received reports for base station in region 1 1322, received reports from base stations in region 2 1324, received reports from base stations in region 3 1326 and a generated network activity report 1328 includes sets of information, e.g., each set of information corresponding to a different region/time interval combination, said generated network activity report to be sent to am analytics server.

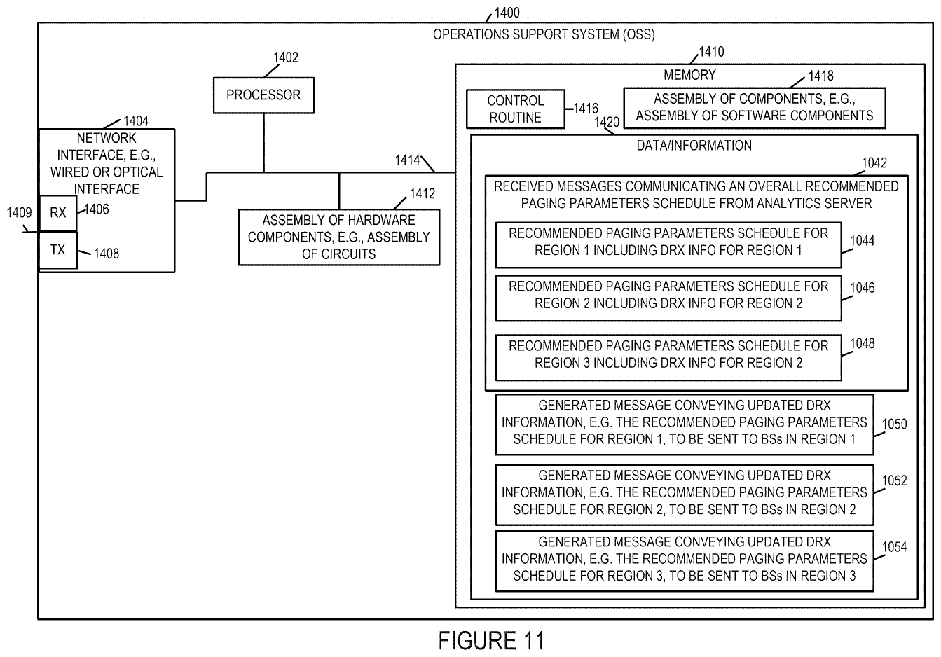

FIG. 11 is a drawing of an exemplary operation support system (OSS) 1400 including configuration management functionality in accordance with an exemplary embodiment. Exemplary OSS 1400 is, e.g., OSS 314 of system 300 of FIG. 3 and/or signaling diagram 400 of FIG. 4.

OSS 1400 includes a processor 1402, e.g., a CPU, a network interface 1404, memory 1410, and assembly of hardware components 1412, e.g., an assembly of circuits, coupled together via bus 1414 over which the various elements may interchange data and information.

Network interface 1404, e.g., a wired or optical interface, includes a receiver (RX) 1406, a transmitter (TX) 1408 and connector 1409 coupled together. Memory 1410 includes a control routine 1416, an assembly of components 1418, e.g., an assembly of software components, and data information 1420. Control routine 1416 includes instructions which when executed by processor 1402 control the OSS 1400 to implement basic operational functions, e.g., read memory, write to memory, control an interface, load a program, subroutine, or app, etc. Assembly of components 1418, e.g., an assembly of software components, e.g., routines, subroutines, applications, etc., includes, e.g., code, e.g., machine executable instructions, which when executed by processor 1402, controls the OSS 1400 to implement steps of a method, e.g., steps of a method which are performed by OSS 314 of system 300 of FIG. 3 and/or of signaling diagram 400 FIG. 4.

Data/information 1420 includes received messages 1042 from an analytics server communicating an overall recommended paging parameters schedule. The overall recommended paging parameters schedule includes a recommended paging parameters schedule for region 1 1044 including DRX information for region 1, e.g., information indicating which selected set of DRX values is to be used in region 1 for each of a plurality of time intervals, a recommended paging parameters schedule for region 2 1046 including DRX information for region 2, e.g., information indicating which selected set of DRX values is to be used in region 2 for each of a plurality of time intervals, and a recommended paging parameters schedule for region 3 1048 including DRX information for region 3, e.g., information indicating which selected set of DRX values is to be used in region 3 for each of a plurality of time intervals. Data/information 1420 further includes a generated message 1050 conveying updated DRX information, e.g., the recommended paging parameters schedule for region 1, to be sent to BSs in region 1, a generated message 1052 conveying updated DRX information, e.g., the recommended paging parameters schedule for region 2, to be sent to BSs in region 2, and a generated message 1054 conveying updated DRX information, e.g., the recommended paging parameters schedule for region 3, to be sent to BSs in region 3.

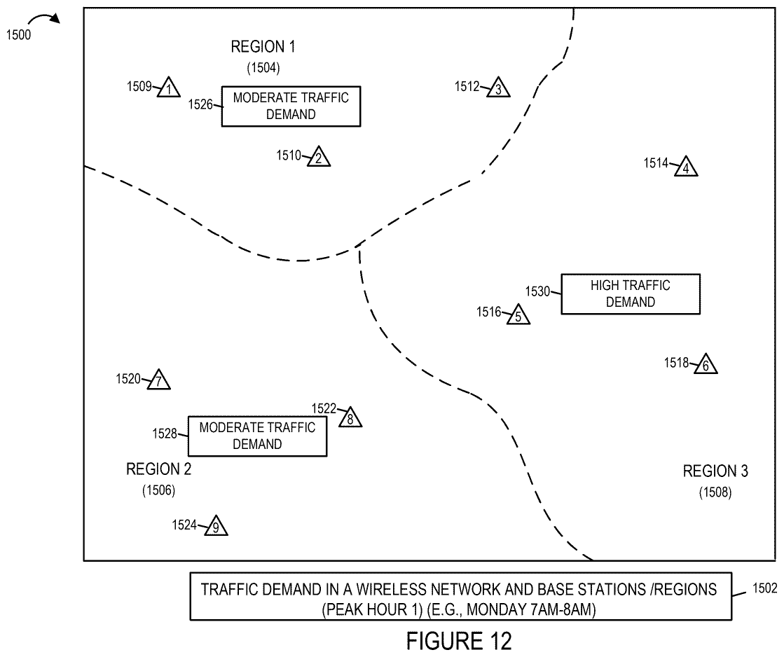

FIG. 12 includes drawing 1500 illustrating exemplary traffic demand in each of three different regions (region 1 1504, region 2 1506, region 3 1508) during a first time period. Information box 1502 indicates that drawing 1500 shows traffic demand on a regional basis corresponding to first time interval, referred to as peak hour 1, e.g., Monday 7 AM-8 AM, for a wireless network including a set of base station in each region. In region 1 1504, which includes base station 1 1508, base station 2 1510 and base station 3 1512, based on network activity analysis, there is a moderate traffic demand, as indicated by information box 1526, for the first time period, referred to as peak hour 1. In region 2 1506, which includes base station 7 1520, base station 8 1522 and base station 9 1524, based on network activity analysis, there is a moderate traffic demand, as indicated by information box 1528, for the first time period, referred to as peak hour 1. In region 3 1508, which includes base station 4 1514, base station 5 1516 and base station 6 1518, based on network activity analysis, there is a moderate traffic demand, as indicated by information box 1530, for the first time period, referred to as peak hour 1.

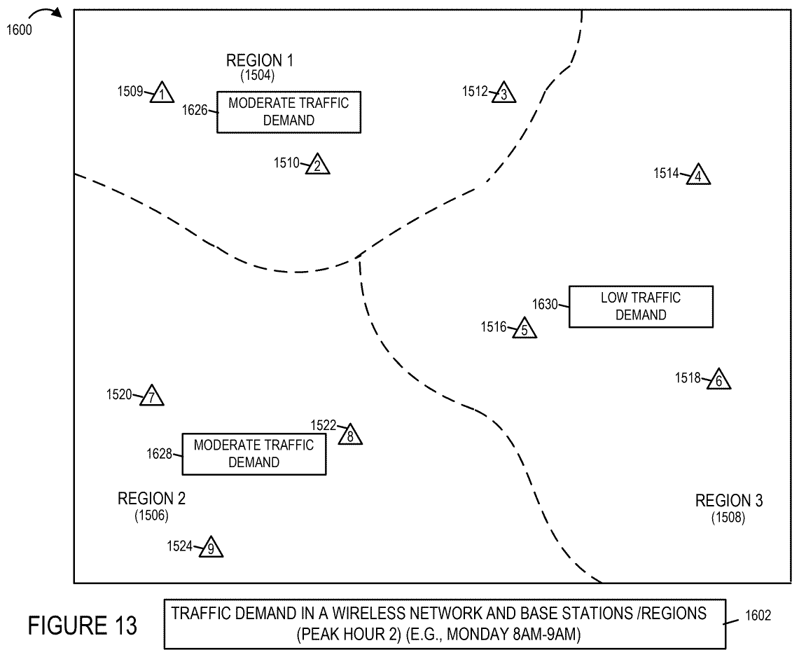

FIG. 13 includes drawing 1600 illustrating exemplary traffic demand in each of three different regions (region 1 1504, region 2 1506, region 3 1508) during a second time period. Information box 1602 indicates that drawing 1600 shows traffic demand on a regional basis corresponding to second time interval, referred to as peak hour 2, e.g., Monday 8 AM-9 AM, for a wireless network including a set of base station in each region. In region 1 1504, which includes base station 1 1508, base station 2 1510 and base station 3 1512, based on network activity analysis, there is a moderate traffic demand, as indicated by information box 1626, for the second time period, referred to as peak hour 2. In region 2 1506, which includes base station 7 1520, base station 8 1522 and base station 9 1524, based on network activity analysis, there is a moderate traffic demand, as indicated by information box 1628, for the second time period, referred to as peak hour 2. In region 3 1508, which includes base station 4 1514, base station 5 1516 and base station 6 1518, based on network activity analysis, there is a low traffic demand, as indicated by information box 1630, for the first time period, referred to as peak hour 1.

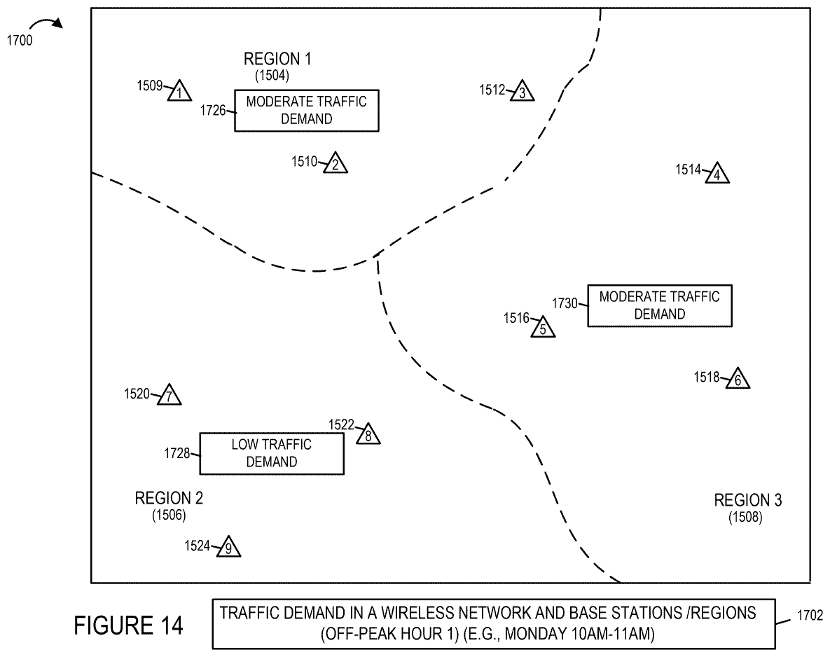

FIG. 14 includes drawing 1700 illustrating exemplary traffic demand in each of three different regions (region 1 1504, region 2 1506, region 3 1508) during a third time period. Information box 1702 indicates that drawing 1700 shows traffic demand on a regional basis corresponding to third time interval, referred to as off-peak hour 1, e.g., Monday 10 AM-11 AM, for a wireless network including a set of base station in each region. In region 1 1504, which includes base station 1 1508, base station 2 1510 and base station 3 1512, based on network activity analysis, there is a moderate traffic demand, as indicated by information box 1726, for the third time period, referred to as off-peak hour 1. In region 2 1506, which includes base station 7 1520, base station 8 1522 and base station 9 1524, based on network activity analysis, there is a low traffic demand, as indicated by information box 1728, for the third time period, referred to as off-peak hour 1. In region 3 1508, which includes base station 4 1514, base station 5 1516 and base station 6 1518, based on network activity analysis, there is a moderate traffic demand, as indicated by information box 1730, for the third time period, referred to as off-peak hour 1.

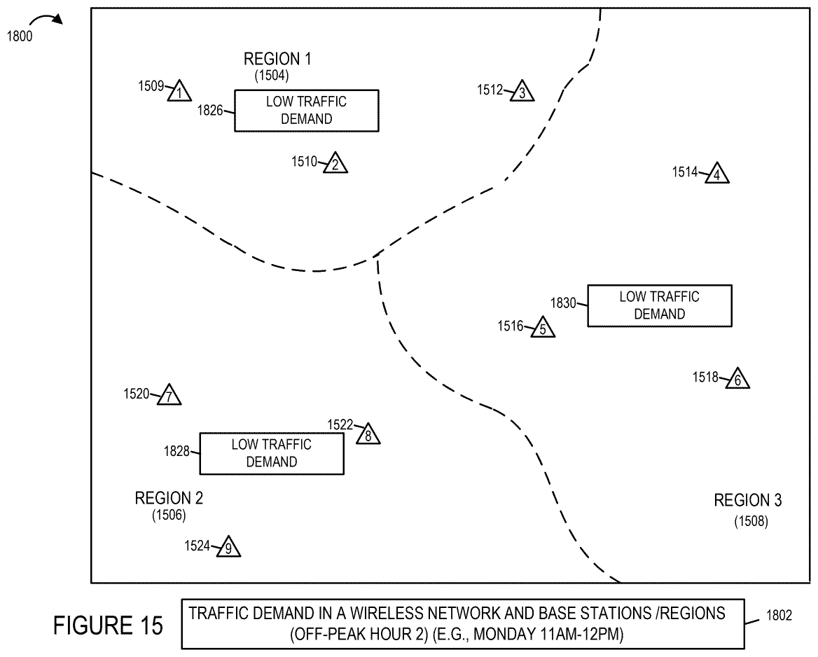

FIG. 15 includes drawing 1800 illustrating exemplary traffic demand in each of three different regions (region 1 1504, region 2 1506, region 3 1508) during a fourth time period. Information box 1802 indicates that drawing 1800 shows traffic demand on a regional basis corresponding to fourth time interval, referred to as off-peak hour 2, e.g., Monday 11 AM-12 PM, for a wireless network including a set of base station in each region. In region 1 1504, which includes base station 1 1508, base station 2 1510 and base station 3 1512, based on network activity analysis, there is a low traffic demand, as indicated by information box 1826, for the fourth time period, referred to as off-peak hour 2. In region 2 1506, which includes base station 7 1520, base station 8 1522 and base station 9 1524, based on network activity analysis, there is a low traffic demand, as indicated by information box 1828, for the fourth time period, referred to as off-peak hour 2. In region 3 1508, which includes base station 4 1514, base station 5 1516 and base station 6 1518, based on network activity analysis, there is a low traffic demand, as indicated by information box 1830, for the fourth time period, referred to as off-peak hour 2.

FIG. 16 includes drawings 1900, 1940 and 1960 illustrating three exemplary pre-defined sets of paging parameter settings in accordance with an exemplary embodiment. Drawing 1900 illustrates a first pre-defined set of paging parameter settings, referred to as DRX parameter set #1 1912, which includes higher ON-time settings for mobiles (UEs) to listen to for paging messages. Successive DRX cycles are shown including DRX cycle #1 1902, DRX cycle #2 1904 and DRX cycle #3 1906. The DRX parameter set #1 values 1912 includes a drx-onDuration Timer value 1908 which is 1200 ms and a drx-Inactivity Timer value 1910 which is 1280 ms.

Drawing 1940 illustrates a second pre-defined set of paging parameter settings referred to as DRX parameter set #2 1952, which includes moderate ON-time settings for mobiles (UEs) to listen to for paging messages. Successive DRX cycles are shown including DRX cycle #1 1942, DRX cycle #2 1944 and DRX cycle #3 1946. The DRX parameter set #2 values 1952 includes a drx-onDuration Timer value 1948 which is 600 ms and a drx-Inactivity Timer value 1950 which is 500 ms.

Drawing 1960 illustrates a third pre-defined set of paging parameter settings referred to as DRX parameter set #3 1972, which includes lower ON-time settings for mobiles (UEs) to listen to for paging messages. Successive DRX cycles are shown including DRX cycle #1 1962, DRX cycle #2 1964 and DRX cycle #3 1966. The DRX parameter set #3 values 1972 includes a drx-onDuration Timer value 1968 which is 300 ms and a drx-Inactivity Timer value 1970 which is 100 ms.

FIG. 17 is a drawing illustrating a table 2000 of an exemplary generated recommended paging parameters schedule, corresponding to 3 regions, in accordance with an exemplary embodiment. Exemplary table 1700 corresponds to the analyzed data corresponding to FIGS. 12-15, using the three pre-defined DRX parameter sets of FIG. 6. In this example the analysis, e.g., performed by an analytics server, which generates the recommended paging parameters schedule, bases the selection of the pre-defined DRX parameter set to use for each region/time interval combination, on traffic demand, e.g. as traffic demand is indicative of paging needs. In various embodiments, other reported network factors are used in addition to traffic demand in determining paging needs for a particular region during a particular time interval.

First column 2002 of table 2000 includes region information. Second column 2004 of table 2000 includes peak hour 1 information. Third column 2006 of table 2000 includes peak hour 2 information. Fourth column 2008 of table 2000 includes off-peak hour 1 information. Fifth column 2010 of table 2000 includes off-peak hour 2 information. Row 2012 indicates that in region 1: i) DRX parameter set #2 (drx-onDuration Timer=600 ms, drx-Inactivity Timer=500 ms) is to be used during the first time interval, referred to as peak hour 1; ii) DRX parameter set #2 (drx-onDuration Timer=600 ms, drx-Inactivity Timer=500 ms) is to be used during the second time interval, referred to as peak hour 2; iii) DRX parameter set #2 (drx-onDuration Timer=600 ms, drx-Inactivity Timer=500 ms) is to be used during the third time interval, referred to as off-peak hour 1; and iv) DRX parameter set #3 (drx-onDuration Timer=300 ms, drx-Inactivity Timer =100 ms) is to be used during the fourth time interval, referred to as off-peak hour 2. Row 2014 indicates that in region 2: i) DRX parameter set #2 (drx-onDuration Timer=600 ms, drx-Inactivity Timer=500 ms) is to be used during the first time interval, referred to as peak hour 1; ii) DRX parameter set #2 (drx-onDuration Timer=600 ms, drx-Inactivity Timer =500 ms) is to be used during the second time interval, referred to as peak hour 2; iii) DRX parameter set #3 (drx-onDuration Timer=300, drx-Inactivity Timer=100 ms) is to be used during the third time interval, referred to as off-peak hour 1; and iv) DRX parameter set #3 (drx-onDuration Timer=300, drx-Inactivity Timer=100 ms) is to be used during the fourth time interval, referred to as off-peak hour 2. Row 2016 indicates that in region 3: i) DRX parameter set #1 (drx-onDuration Timer=1200 ms, drx-Inactivity Timer=1280 ms) is to be used during the first time interval, referred to as peak hour 1; ii) DRX parameter set #3 (drx-onDuration Timer=300 ms, drx-Inactivity Timer=100 ms) is to be used during the second time interval, referred to as peak hour 2; iii) DRX parameter set #2 (drx-onDuration Timer=600 ms, drx-Inactivity Timer=500 ms) is to be used during the third time interval, referred to as off-peak hour 1; and iv) DRX parameter set #3 (drx-onDuration Timer=300 ms, drx-Inactivity Timer=100 ms) is to be used during the fourth time interval, referred to as off-peak hour 2.

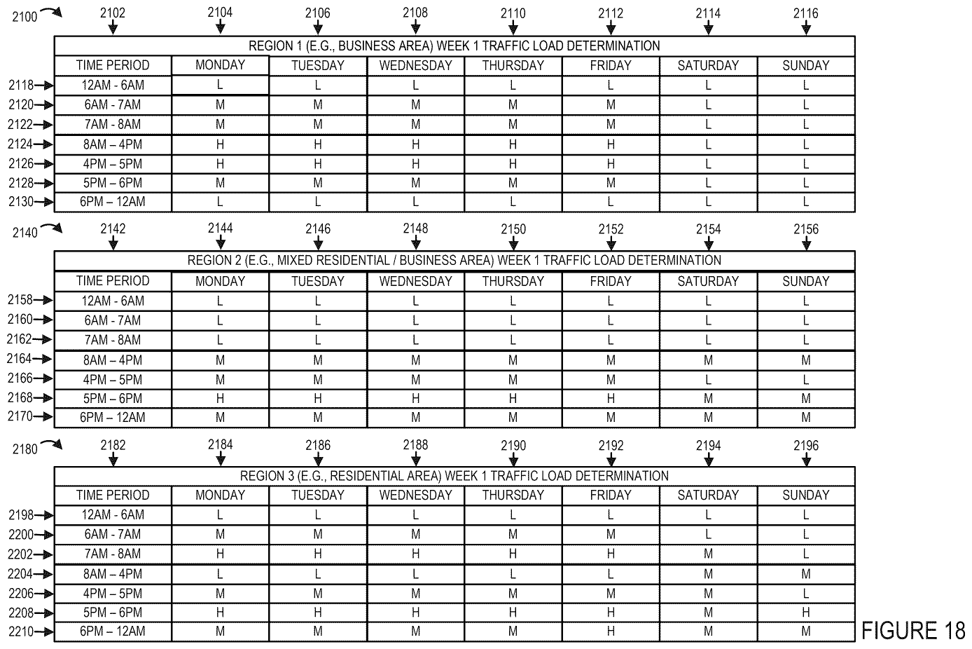

FIG. 18 includes table 2100 illustrating exemplary determined traffic load in region 1, e.g., which is a business area, during time periods of week 1, in accordance with an exemplary embodiment. FIG. 18 further includes table 2140 illustrating exemplary determined traffic load in region 2, which is a mixed residential/business area, during time periods of week 1, in accordance with an exemplary embodiment. FIG. 18 further includes table 2180 illustrating exemplary determined traffic load in region 3, e.g., a residential area, during time periods of week 1, in accordance with an exemplary embodiment.

Table 2100 includes: column 2102, which includes information identifying time periods, column 2104, which includes information identifying the determined region 1 traffic load for each of the time periods during Monday, column 2106, which includes information identifying the determined region 1 traffic load for each of the time periods during Tuesday, column 2108, which includes information identifying the determined region 1 traffic load for each of the time periods during Wednesday, column 2110, which includes information identifying the determined region 1 traffic load for each of the time periods during Thursday, column 2112, which includes information identifying the determined region 1 traffic load for each of the time periods during Friday, column 2114, which includes information identifying the determined region 1 traffic load for each of the time periods during Saturday, and column 2116, which includes information identifying the determined region 1 traffic load for each of the time periods during Sunday, where an entry of L indicates a low traffic load, an entry of M indicates a medium traffic load and an entry of H indicates a high traffic load. Row 2118 includes region 1 traffic load determination entries corresponding to the time period of 12 AM-6 AM for each day of the week. Row 2120 includes region 1 traffic load determination entries corresponding to the time period of 6 AM-7 AM for each day of the week. Row 2122 includes region 1 traffic load determination entries corresponding to the time period of 7 AM-8 AM for each day of the week. Row 2124 includes region 1 traffic load determination entries corresponding to the time period of 8 AM-4 PM for each day of the week. Row 2126 includes region 1 traffic load determination entries corresponding to the time period of 4 PM-5 PM for each day of the week. Row 2128 includes region 1 traffic load determination entries corresponding to the time period of 5PM-6PM for each day of the week. Row 2130 includes region 1 traffic load determination entries corresponding to the time period of 6 PM-12 AM for each day of the week.

Table 2140 includes: column 2142, which includes information identifying time periods, column 2144, which includes information identifying the determined region 2 traffic load for each of the time periods during Monday, column 2146, which includes information identifying the determined region 2 traffic load for each of the time periods during Tuesday, column 2148, which includes information identifying the determined region 2 traffic load for each of the time periods during Wednesday, column 2150, which includes information identifying the determined region 2 traffic load for each of the time periods during Thursday, column 2152, which includes information identifying the determined region 2 traffic load for each of the time periods during Friday, column 2154, which includes information identifying the determined region 2 traffic load for each of the time periods during Saturday, and column 2156, which includes information identifying the determined region 2 traffic load for each of the time periods during Sunday, where an entry of L indicates a low traffic load, an entry of M indicates a medium traffic load and an entry of H indicates a high traffic load. Row 2158 includes region 2 traffic load determination entries corresponding to the time period of 12 AM-6 AM for each day of the week. Row 2160 includes region 2 traffic load determination entries corresponding to the time period of 6 AM-7 AM for each day of the week. Row 2162 includes region 2 traffic load determination entries corresponding to the time period of 7 AM-8 AM for each day of the week. Row 2164 includes region 2 traffic load determination entries corresponding to the time period of 8 AM-4 PM for each day of the week. Row 2166 includes region 2 traffic load determination entries corresponding to the time period of 4 PM-5 PM for each day of the week. Row 2168 includes region 2 traffic load determination entries corresponding to the time period of 5 PM-6 PM for each day of the week. Row 2170 includes region 2 traffic load determination entries corresponding to the time period of 6 PM-12 AM for each day of the week.

Table 2180 includes: column 2182, which includes information identifying time periods, column 2184, which includes information identifying the determined region 3 traffic load for each of the time periods during Monday, column 2186, which includes information identifying the determined region 3 traffic load for each of the time periods during Tuesday, column 2188, which includes information identifying the determined region 3 traffic load for each of the time periods during Wednesday, column 2190, which includes information identifying the determined region 3 traffic load for each of the time periods during Thursday, column 2192, which includes information identifying the determined region 3 traffic load for each of the time periods during Friday, column 2194, which includes information identifying the determined region 3 traffic load for each of the time periods during Saturday, and column 2196, which includes information identifying the determined region 3 traffic load for each of the time periods during Sunday, where an entry of L indicates a low traffic load, an entry of M indicates a medium traffic load and an entry of H indicates a high traffic load. Row 2198 includes region 3 traffic load determination entries corresponding to the time period of 12 AM-6 AM for each day of the week. Row 2200 includes region 3 traffic load determination entries corresponding to the time period of 6 AM-7 AM for each day of the week. Row 2202 includes region 3 traffic load determination entries corresponding to the time period of 7 AM-8 AM for each day of the week. Row 2204 includes region 3 traffic load determination entries corresponding to the time period of 8 AM-4 PM for each day of the week. Row 2206 includes region 3 traffic load determination entries corresponding to the time period of 4 PM-5 PM for each day of the week. Row 2208 includes region 3 traffic load determination entries corresponding to the time period of 5 PM-6 PM for each day of the week. Row 2210 includes region 3 traffic load determination entries corresponding to the time period of 6 PM-12 AM for each day of the week.

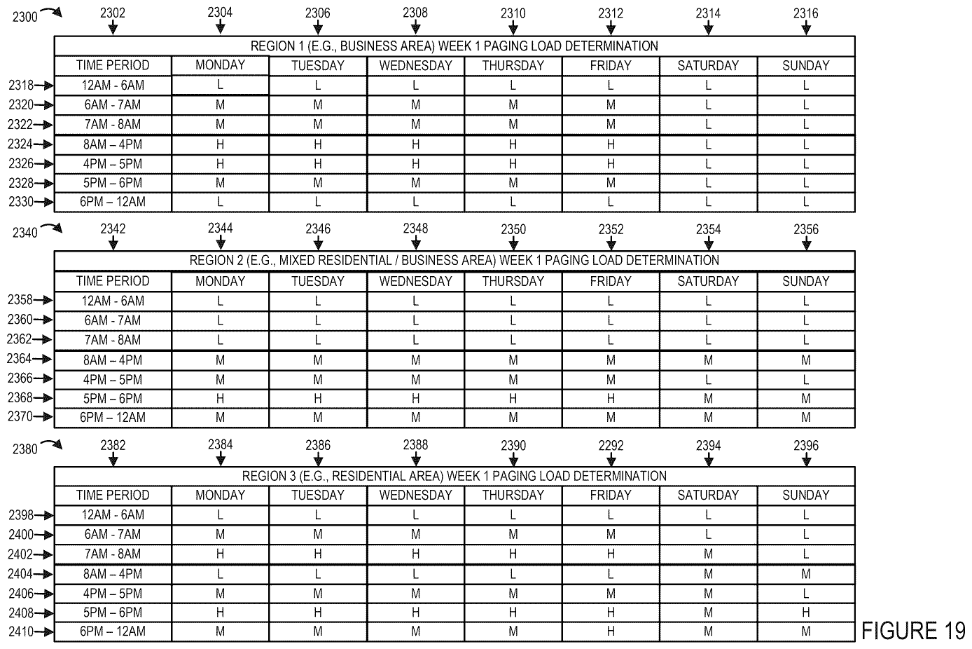

FIG. 19 includes table 2300 illustrating exemplary determined paging load in region 1, e.g., which is a business area, during time periods of week 1, in accordance with an exemplary embodiment. FIG. 19 further includes table 2340 illustrating exemplary determined paging load in region 2, which is a mixed residential/business area, during time periods of week 1, in accordance with an exemplary embodiment. FIG. 19 further includes table 2280 illustrating exemplary determined paging load in region 3, e.g., a residential area, during time periods of week 1, in accordance with an exemplary embodiment.

Table 2300 includes: column 2302, which includes information identifying time periods, column 2304, which includes information identifying the determined region 1 paging load for each of the time periods during Monday, column 2306, which includes information identifying the determined region 1 paging load for each of the time periods during Tuesday, column 2308, which includes information identifying the determined region 1 paging load for each of the time periods during Wednesday, column 2310, which includes information identifying the determined region 1 paging load for each of the time periods during Thursday, column 2312, which includes information identifying the determined region 1 paging load for each of the time periods during Friday, column 2314, which includes information identifying the determined region 1 paging load for each of the time periods during Saturday, and column 2316, which includes information identifying the determined region 1 paging load for each of the time periods during Sunday, where an entry of L indicates a low paging load, an entry of M indicates a medium paging load and an entry of H indicates a high paging load. Row 2318 includes region 1 paging load determination entries corresponding to the time period of 12 AM-6 AM for each day of the week. Row 2320 includes region 1 paging load determination entries corresponding to the time period of 6 AM-7 AM for each day of the week. Row 2322 includes region 1 paging load determination entries corresponding to the time period of 7 AM-8 AM for each day of the week. Row 2124 includes region 1 paging load determination entries corresponding to the time period of 8 AM-4 PM for each day of the week. Row 2326 includes region 1 paging load determination entries corresponding to the time period of 4 PM-5 PM for each day of the week. Row 2128 includes region 1 paging load determination entries corresponding to the time period of 5 PM-6 PM for each day of the week. Row 2330 includes region 1 paging load determination entries corresponding to the time period of 6 PM-12 AM for each day of the week.

Table 2340 includes: column 2342, which includes information identifying time periods, column 2344, which includes information identifying the determined region 2 paging load for each of the time periods during Monday, column 2346, which includes information identifying the determined region 2 paging load for each of the time periods during Tuesday, column 2348, which includes information identifying the determined region 2 paging load for each of the time periods during Wednesday, column 2350, which includes information identifying the determined region 2 paging load for each of the time periods during Thursday, column 2352, which includes information identifying the determined region 2 paging load for each of the time periods during Friday, column 2354, which includes information identifying the determined region 2 paging load for each of the time periods during Saturday, and column 2356, which includes information identifying the determined region 2 paging load for each of the time periods during Sunday, where an entry of L indicates a low paging load, an entry of M indicates a medium paging load and an entry of H indicates a high paging load. Row 2358 includes region 2 paging load determination entries corresponding to the time period of 12 AM-6 AM for each day of the week. Row 2360 includes region 2 paging load determination entries corresponding to the time period of 6 AM-7 AM for each day of the week. Row 2362 includes region 2 paging load determination entries corresponding to the time period of 7 AM-8 AM for each day of the week. Row 2364 includes region 3 paging load determination entries corresponding to the time period of 8 AM-4 PM for each day of the week. Row 2366 includes region 2 paging load determination entries corresponding to the time period of 4 PM-5 PM for each day of the week. Row 2368 includes region 2 paging load determination entries corresponding to the time period of 5 PM-6 PM for each day of the week. Row 2370 includes region 2 paging load determination entries corresponding to the time period of 6 PM-12 AM for each day of the week.

Table 2380 includes: column 2382, which includes information identifying time periods, column 2384, which includes information identifying the determined region 3 paging load for each of the time periods during Monday, column 2386, which includes information identifying the determined region 3 paging load for each of the time periods during Tuesday, column 2388, which includes information identifying the determined region 3 paging load for each of the time periods during Wednesday, column 2390, which includes information identifying the determined region 3 paging load for each of the time periods during Thursday, column 2392, which includes information identifying the determined region 3 paging load for each of the time periods during Friday, column 2394, which includes information identifying the determined region 3 paging load for each of the time periods during Saturday, and column 2396, which includes information identifying the determined region 3 paging load for each of the time periods during Sunday, where an entry of L indicates a low paging load, an entry of M indicates a medium paging load and an entry of H indicates a high paging load. Row 2398 includes region 3 paging load determination entries corresponding to the time period of 12 AM-6 AM for each day of the week. Row 2400 includes region 3 paging load determination entries corresponding to the time period of 6 AM-7 AM for each day of the week. Row 2402 includes region 3 paging load determination entries corresponding to the time period of 7 AM-8 AM for each day of the week. Row 2404 includes region 3 paging load determination entries corresponding to the time period of 8 AM-4 PM for each day of the week. Row 2406 includes region 3 paging load determination entries corresponding to the time period of 4 PM-5 PM for each day of the week. Row 2408 includes region 3 paging load determination entries corresponding to the time period of 5 PM-6 PM for each day of the week. Row 2410 includes region 3 paging load determination entries corresponding to the time period of 6 PM-12 AM for each day of the week.

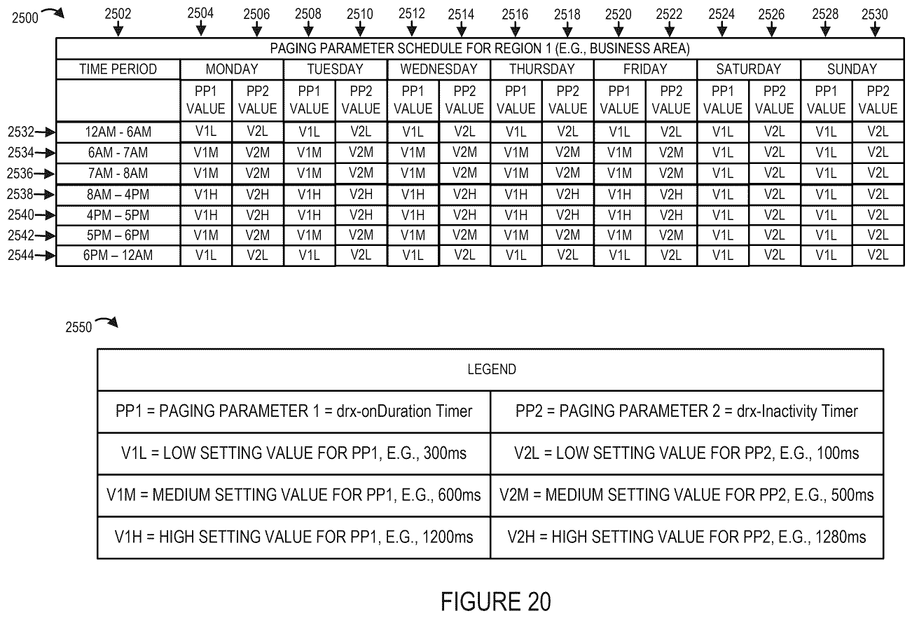

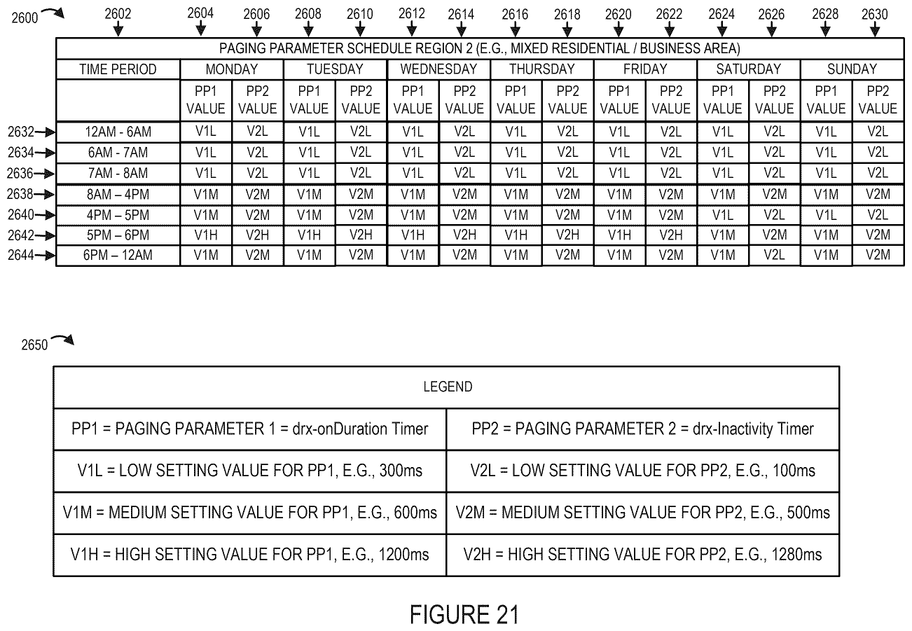

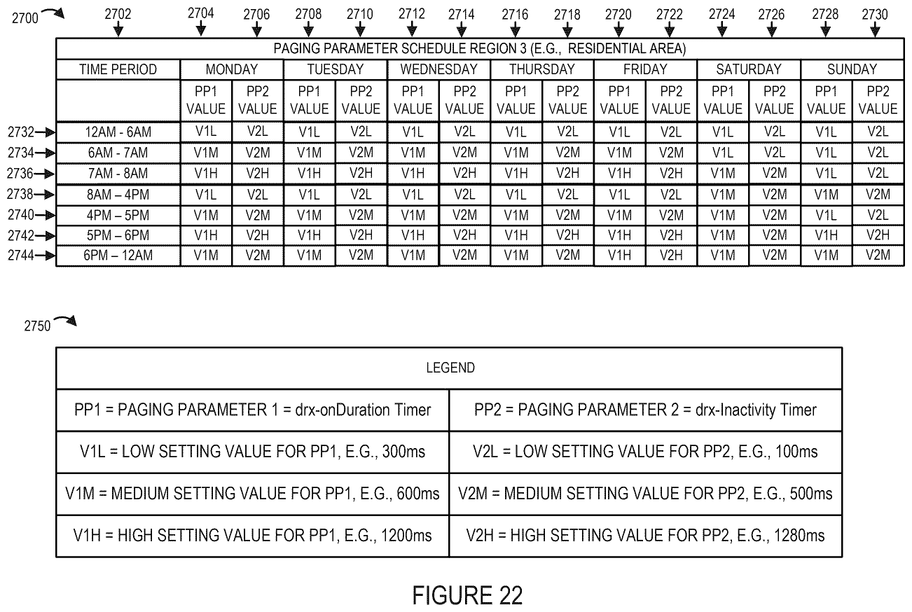

FIGS. 20, 21 and 22 illustrate in separate figures, exemplary paging parameter schedules for each of the first, second and third regions respectively. The schedules for each region are communicated from the analytics server 318 to the OSS 314 as a single set of information 532, e.g., schedule for multiple regions, or as separate per regions schedules. The OSS 314 communicates the prior of the schedule or schedules relevant to a region to the base stations in the corresponding region for use in controlling paging parameters in accordance with the schedule applicable to the region. For example the second shown in FIG. 20 is communicated to base stations in region 1, the schedule in FIG. 21 is communicated to base stations in region 2 and the schedule shown in FIG. 22 is communicated to base stations in region 3.

FIG. 20 includes table 2500 illustrating an exemplary paging parameter schedule for a first region, e.g., a business area, in accordance with an exemplary embodiment, and a corresponding legend 2550. Exemplary paging parameter schedule for region 1 of table 2500 is, e.g., generated, e.g., by an analytics server, in response to determined region 1 traffic load determination table 2100 of FIG. 18 and/or determined region 1 paging load determination table 2300 of FIG. 19. Legend 2500 indicates: i) PP1=paging parameter 1=drx-onDurationTimer; ii) PP2=paging parameter 2=drx-InactivityTimer; iii) V1L=low setting value for PP 1, e.g., 300 ms; iv) V2L=low setting value for PP2, e.g., 100 ms; v) V1M=medium setting value for PP1, e.g., 600 ms; vi) V2M=medium setting value for PP2, e.g., 500 ms; vii) V1H=high setting value for PP1, e.g., 1200 ms; and viii) V2H=high setting value for PP2, e.g., 1280 ms.

Table 2500 includes: column 2502, which includes information identifying time periods, column 2504, which includes information identifying the determined region 1 PP1 value for each of the time periods during Monday, column 2506, which includes information identifying the determined region 1 PP2 value for each of the time periods during Monday, column 2508, which includes information identifying the determined region 1 PP1 value for each of the time periods during Tuesday, column 2510, which includes information identifying the determined region 1 PP2 value for each of the time periods during Tuesday, column 2512, which includes information identifying the determined region 1 PP1 value for each of the time periods during Wednesday, column 2514, which includes information identifying the determined region 1 PP2 value for each of the time periods during Wednesday, column 2516, which includes information identifying the determined region 1 PP1 value for each of the time periods during Thursday, column 2518, which includes information identifying the determined region 1 PP2 value for each of the time periods during Thursday, column 2520, which includes information identifying the determined region 1 PP1 value for each of the time periods during Friday, column 2522, which includes information identifying the determined region 1 PP2 value for each of the time periods during Friday, column 2524, which includes information identifying the determined region 1 PP1 value for each of the time periods during Saturday, column 2526, which includes information identifying the determined region 1 PP2 value for each of the time periods during Saturday, column 2528, which includes information identifying the determined region 1 PP1 value for each of the time periods during Sunday, and column 2530, which includes information identifying the determined region 1 PP2 values for each of the time periods during Sunday. Row 2532 includes region 1 PP1 and PP2 value entries corresponding to the time period of 12 AM-6 AM for each day of the week. Row 2534 includes region 1 PP1 value and PP2 value entries corresponding to the time period of 6 AM-7 AM for each day of the week. Row 2536 includes region 1 PP1 value and PP2 value entries corresponding to the time period of 7 AM-8 AM for each day of the week. Row 2538 includes region 1 PP1 value and PP2 value entries corresponding to the time period of 8 AM-4 PM for each day of the week. Row 2540 includes region 1 PP1 value and PP2 value entries corresponding to the time period of 4 PM-5 PM for each day of the week. Row 2542 includes region 1 PP1 value and PP2 value entries corresponding to the time period of 5 PM-6 PM for each day of the week. Row 2534 includes region 1 PP1 value and PP2 value entries corresponding to the time period of 6 PM-12 AM for each day of the week.

FIG. 21 includes table 2600 illustrating an exemplary paging parameter schedule for a second region, e.g., a mixed residential/business area, in accordance with an exemplary embodiment, and a corresponding legend 2650. Exemplary paging parameter schedule for region 2 of table 2600 is, e.g., generated, e.g., by an analytics server, in response to determined region 2 traffic load determination table 2140 of FIG. 18 and/or determined region 2 paging load determination table 2340 of FIG. 19. Legend 2600 indicates: i) PP1=paging parameter 1=drx-onDurationTimer; ii) PP2=paging parameter 2=drx-InactivityTimer; iii) V1L=low setting value for PP1, e.g., 300 ms; iv) V2L=low setting value for PP2, e.g., 100 ms; v) V1M=medium setting value for PP1, e.g., 600 ms; vi) V2M=medium setting value for PP2, e.g., 500 ms; vii) V1H=high setting value for PP1, e.g., 1200 ms; and viii) V2H=high setting value for PP2, e.g., 1280 ms.

Table 2600 includes: column 2602, which includes information identifying time periods, column 2604, which includes information identifying the determined region 2 PP1 value for each of the time periods during Monday, column 2606, which includes information identifying the determined region 2 PP2 value for each of the time periods during Monday, column 2608, which includes information identifying the determined region 2 PP1 value for each of the time periods during Tuesday, column 2610, which includes information identifying the determined region 2 PP2 value for each of the time periods during Tuesday, column 2612, which includes information identifying the determined region 2 PP1 value for each of the time periods during Wednesday, column 2614, which includes information identifying the determined region 2 PP2 value for each of the time periods during Wednesday, column 2616, which includes information identifying the determined region 2 PP1 value for each of the time periods during Thursday, column 2618, which includes information identifying the determined region 2 PP2 value for each of the time periods during Thursday, column 2620, which includes information identifying the determined region 2 PP1 value for each of the time periods during Friday, column 2622, which includes information identifying the determined region 2 PP2 value for each of the time periods during Friday, column 2624, which includes information identifying the determined region 2 PP1 value for each of the time periods during Saturday, column 2626, which includes information identifying the determined region 2 PP2 value for each of the time periods during Saturday, column 2628, which includes information identifying the determined region 2 PP1 value for each of the time periods during Sunday, and column 2630, which includes information identifying the determined region 2 PP2 values for each of the time periods during Sunday. Row 2632 includes region 2 PP1 and PP2 value entries corresponding to the time period of 12 AM-6 AM for each day of the week. Row 2634 includes region 2 PP1 value and PP2 value entries corresponding to the time period of 6 AM-7 AM for each day of the week. Row 2636 includes region 2 PP1 value and PP2 value entries corresponding to the time period of 7 AM-8 AM for each day of the week. Row 2638 includes region 2 PP1 value and PP2 value entries corresponding to the time period of 8 AM-4 PM for each day of the week. Row 2640 includes region 2 PP1 value and PP2 value entries corresponding to the time period of 4 PM-5 PM for each day of the week. Row 2642 includes region 2 PP1 value and PP2 value entries corresponding to the time period of 5 PM-6 PM for each day of the week. Row 2634 includes region 2 PP1 value and PP2 value entries corresponding to the time period of 6 PM-12 AM for each day of the week.

FIG. 22 includes table 2700 illustrating an exemplary paging parameter schedule for a third region, e.g., a residential area, in accordance with an exemplary embodiment, and a corresponding legend 2750. Exemplary paging parameter schedule for region 3 of table 2700 is, e.g., generated, e.g., by an analytics server, in response to determined region 3 traffic load determination table 2180 of FIG. 18 and/or determined region 3 paging load determination table 2380 of FIG. 19. Legend 2700 indicates: i) PP1=paging parameter 1=drx-onDurationTimer; ii) PP2=paging parameter 2=drx-InactivityTimer; iii) V1L=low setting value for PP1, e.g., 300 ms; iv) V2L=low setting value for PP2, e.g., 100 ms; v) V1M=medium setting value for PP1, e.g., 600 ms; vi) V2M=medium setting value for PP2, e.g., 500 ms; vii) V1H=high setting value for PP1, e.g., 1200 ms; and viii) V2H=high setting value for PP2, e.g., 1280 ms.

Table 2700 includes: column 2702, which includes information identifying time periods, column 2704, which includes information identifying the determined region 3 PP1 value for each of the time periods during Monday, column 2706, which includes information identifying the determined region 3 PP2 value for each of the time periods during Monday, column 2708, which includes information identifying the determined region 3 PP1 value for each of the time periods during Tuesday, column 2710, which includes information identifying the determined region 3 PP2 value for each of the time periods during Tuesday, column 2712, which includes information identifying the determined region 3 PP1 value for each of the time periods during Wednesday, column 2714, which includes information identifying the determined region 3 PP2 value for each of the time periods during Wednesday, column 2716, which includes information identifying the determined region 3 PP1 value for each of the time periods during Thursday, column 2718, which includes information identifying the determined region 3 PP2 value for each of the time periods during Thursday, column 2720, which includes information identifying the determined region 3 PP1 value for each of the time periods during Friday, column 2722, which includes information identifying the determined region 3 PP2 value for each of the time periods during Friday, column 2724, which includes information identifying the determined region 3 PP1 value for each of the time periods during Saturday, column 2726, which includes information identifying the determined region 3 PP2 value for each of the time periods during Saturday, column 2728, which includes information identifying the determined region 3 PP1 value for each of the time periods during Sunday, and column 2730, which includes information identifying the determined region 3 PP2 values for each of the time periods during Sunday. Row 2732 includes region 3 PP1 and PP2 value entries corresponding to the time period of 12 AM-6 AM for each day of the week. Row 2734 includes region 3 PP1 value and PP2 value entries corresponding to the time period of 6 AM-7 AM for each day of the week. Row 2736 includes region 3 PP1 value and PP2 value entries corresponding to the time period of 7 AM-8 AM for each day of the week. Row 2738 includes region 3 PP1 value and PP2 value entries corresponding to the time period of 8 AM-4 PM for each day of the week. Row 2740 includes region 3 PP1 value and PP2 value entries corresponding to the time period of 4 PM-5 PM for each day of the week. Row 2742 includes region 3 PP1 value and PP2 value entries corresponding to the time period of 5 PM-6 PM for each day of the week. Row 2734 includes region 3 PP1 value and PP2 value entries corresponding to the time period of 6 PM-12 AM for each day of the week.

### Numbered Exemplary Method Embodiments

Numbered Exemplary Method Embodiment 1. A method of controlling paging settings in a communications network (300), comprising: receiving (804 or 526), at an analytics server (318), a network activity report (524) including information corresponding to at least a first region (e.g., receive a network activity report (524) including information about network activity for one or more paging regions for one or more periods of time, where the report (524) in some cases includes network activity including paging information for a first, second and third region for a period of time including hours and/or days of traffic information representing multiple hourly periods of time including at least a first period of time corresponding to a first hour and day of a week for which network activity information including paging information is collected and provided in report 524) first paging region 1 364); analyzing (e.g., determine)(806 or 528) the received network activity report (524) to determine a level of paging activity (e.g. paging load) during one or more periods of time for at least a first paging region (e.g., hourly periods during a day where the paging load is determined for at least a first paging region for a first time period), said one or more periods of time including at least a first period of time (e.g., first hourly period of a weekday, e.g., Monday, Tuesday, Wednesday, Thursday or Friday); generating (808 or 529) one or more paging setting recommendations (e.g., at least a first paging parameter recommendation for a first time period corresponding to the first region recommended paging parameters setting schedule), said step of generating one or more paging setting recommendations including generating a paging setting parameter recommendation for at least the first region based on the determined level of paging activity in the first region during the first period of time; and communicating (835 or 530) the paging setting recommendation to a management system (e.g., operations support system (OSS) (314) including configuration management functionality).

Numbered Exemplary Method Embodiment 1B. The method of Numbered Exemplary Method Embodiment 1, further comprising: operating the management system (314) to configure (536) base stations (324, 326) in the first region (364) based on the paging setting recommendation.

Numbered Exemplary Method Embodiment 1A The method of Numbered Exemplary Method Embodiment 1, wherein the received network activity report includes traffic demand information, andwherein analyzing the received network activity report to determine a level of paging activity during one or more periods of time for at least a first paging region includes determining paging load for a region during a time period based on traffic demand in the region during the time period (e.g., high traffic demand corresponds to high paging load, medium traffic demand corresponds to medium paging load, and low traffic demand corresponds to low paging load).

Numbered Exemplary Method Embodiment 2. The method of Numbered Exemplary Method Embodiment 1, wherein the first period of time is a recurring period of time (e.g., day of week and hour period within the day of the week); and wherein communicating (835 or 530) the paging setting recommendation to the management system includes sending a recommended paging parameter schedule to the management system.

Numbered Exemplary Method Embodiment 3. The method of Numbered Exemplary Method Embodiment 2, wherein the recommended paging parameter schedule includes a recommended paging drx-onDuration Timer value to be used for the first region during the first time period.

Numbered Exemplary Method Embodiment 3A. The method of Numbered Exemplary Method Embodiment 3, wherein the recommended paging parameter schedule includes a recommended paging drx-Inactivity Timer value to be used for the first region during the first time period.

Numbered Exemplary Method Embodiment 4. The method of Numbered Exemplary Method Embodiment 3, wherein the recommended paging parameter schedule includes different recommended paging drx-onDuration Timer values for different periods of time in the first region based on different paging loads determined to correspond to said different periods of time.

Numbered Exemplary Method Embodiment 4A. The method of Numbered Exemplary Method Embodiment 4, wherein the recommended paging parameter schedule includes different recommended paging drx-Inactivity Timer values for different periods of time in the first region based on different paging loads determined to correspond to said different periods of time.

Numbered Exemplary Method Embodiment 4AA. The method of Numbered Exemplary Method Embodiment 4, wherein the recommended paging parameter schedule includes recommended paging parameters for multiple regions, said multiple regions including a first region (364), a second region (366) and a third region (368).

Numbered Exemplary Method Embodiment 4B. The method of Numbered Exemplary Method Embodiment 4A, wherein the recommended paging parameter schedule includes different paging parameters for multiple different time periods for each of said first, second and third regions.

Numbered Exemplary Method Embodiment 5. The method of Numbered Exemplary Method Embodiment 2, further comprising: generating (808 or 529) a paging setting recommendation for at least the first region based on the determined level of paging activity in the first region during the first period of time, generating the paging setting recommendation including comparing (812 and/or 816) the determined level of paging activity in the first region to one or more paging load ranges to determine which of a plurality of paging load ranges, for which predetermined recommended paging parameters are stored, the determined level of paging activity in the first region corresponds; and recommending (822) a set of predetermined paging parameter values corresponding to the determined paging load range be used for the first region.

Numbered Exemplary Method Embodiment 5A. The method of Numbered Exemplary Method Embodiment 5, wherein the recommended set of predetermined paging parameter values includes at least a drx-onDuration Timer parameter value.

Numbered Exemplary Method Embodiment 5B. The method Numbered Exemplary Method Embodiment 5, wherein the recommended set of predetermined paging parameter values includes a drx-onDuration Timer parameter value and a drx-Inactivity Timer parameter value.

Numbered Exemplary Method Embodiment 6. The method of Numbered Exemplary Method Embodiment 5, wherein plurality of paging load ranges for which predetermined recommended paging parameters are stored includes at least a high paging load range, a medium paging load range and a low paging load range.

Numbered Exemplary Method Embodiment 7. The method of Numbered Exemplary Method Embodiment 6, wherein the stored paging parameters corresponding to the high paging load range includes a high drx-onDuration Timer paging parameter value (e.g., 1200 ms) and a high drx-Inactivity Timer paging parameter value (e.g., 1280 ms).

Numbered Exemplary Method Embodiment 8. The method of Numbered Exemplary Method Embodiment 7, wherein the stored paging parameters corresponding to the medium paging load range include a medium drx-onDuration Timer paging parameter value (e.g., 600 ms) corresponding to a shorter on paging duration than the high drx-onDuration Timer paging parameter value (e.g., 1200 ms) and a medium drx-Inactivity Timer paging parameter value (e.g., 500 ms) corresponding to a shorter drx-Inactivity Timer time period than said high drx-Inactivity paging parameter value (e.g., 1280 ms).

Numbered Exemplary Method Embodiment 9. The method of Numbered Exemplary Method Embodiment 7, wherein the stored paging parameters corresponding to the low paging load range include a low drx-onDuration Timer paging parameter value (e.g., 300 ms) corresponding to a shorter on paging duration than the high drx-onDuration Timer paging parameter value and medium drx-onDuration Timer paging parameter values and a low drx-Inactivity Timer paging parameter value (e.g., 100 ms) corresponding to a shorter drx-Inactivity time period than said high drx-Inactivity Timer paging parameter value and said medium drx-Inactivity Timer paging parameter value.

Numbered Exemplary Method Embodiment 10. The method of Numbered Exemplary Method Embodiment 9, wherein generating (808 or 529) one or more paging setting recommendations includes generating paging setting recommendations for at least three different regions and at least 3 different hourly time periods.

### Numbered Exemplary System Embodiments

Numbered Exemplary System Embodiment 1. A system for controlling paging settings in a communications network (300), comprising: an analytics server (318 or 1000) including: memory (1020) storing information indicating predetermined paging parameters values to be used for different paging load ranges; and a processor (1002) configured to control the analytics server (318) to: receive (804 or 526) a network activity report (524) including information corresponding to at least a first region (e.g., receive a network activity report (524) including information about network activity for one or more paging regions for one or more periods of time, where the report (524) in some cases includes network activity including paging information for a first, second and third region for a period of time including hours and/or days of traffic information representing multiple hourly periods of time including at least a first period of time corresponding to a first hour and day of a week for which network activity information including paging information is collected and provided in report 524) first paging region 1 364); analyze (e.g., determine)(806 or 528) the received network activity report (524) to determine a level of paging activity (e.g. paging load) during one or more periods of time for at least a first paging region (e.g., hourly periods during a day where the paging load is determined for at least a first paging region for a first time period), said one or more periods of time including at least a first period of time (e.g., first hourly period of a weekday, e.g., Monday, Tuesday, Wednesday, Thursday or Friday); generate (808 or 529) one or more paging setting recommendations (e.g., at least a first paging parameter recommendation for a first time period corresponding to the first region recommended paging parameters setting schedule), said step of generating one or more paging setting recommendations including generating a paging setting parameter recommendation for at least the first region based on the determined level of paging activity in the first region during the first period of time; and communicate (835 or 530) the paging setting recommendation to a management system (e.g., operations support system (OSS) (314) including configuration management functionality).

Numbered Exemplary System Embodiment 1B. The system of Numbered Exemplary System Embodiment 1, further comprising: a management system (314) (e.g. an OSS including configuration management functionality) configured to control the (536) base stations (324, 326) in the first region (364) based on the paging setting recommendation.

Numbered Exemplary System Embodiment 1A The system of Numbered Exemplary System Embodiment 1, wherein the received network activity report includes traffic demand information, and wherein the processor (1002) is configured, as part of being configured to control the analytics server to analyze the received network activity report to determine a level of paging activity during one or more periods of time for at least a first paging region, to determine paging load for a region during a time period based on traffic demand in the region during the time period (e.g., high traffic demand corresponds to high paging load, medium traffic demand corresponds to medium paging load, and low traffic demand corresponds to low paging load).

Numbered Exemplary System Embodiment 2. The system of Numbered Exemplary System Embodiment 1, wherein the first period of time is a recurring period of time (e.g., day of week and hour period within the day of the week); and wherein the processor (1002) is configured to control the analytics server to send a recommended paging parameter schedule to the management system as part of being configured to control the analytics server to communicate (835 or 530) the paging setting recommendation to the management system.

Numbered Exemplary System Embodiment 3. The system of Numbered Exemplary System Embodiment 2, wherein the recommended paging parameter schedule includes a recommended paging drx-onDuration Timer value to be used for the first region during the first time period.

Numbered Exemplary System Embodiment 3A. The system of Numbered Exemplary System Embodiment 3, wherein the recommended paging parameter schedule includes a recommended paging drx-Inactivity Timer value to be used for the first region during the first time period.

Numbered Exemplary System Embodiment 4. The system of Numbered Exemplary System Embodiment 3, wherein the recommended paging parameter schedule includes different recommended paging drx-onDuration Timer values for different periods of time in the first region based on different paging loads determined to correspond to said different periods of time.

Numbered Exemplary System Embodiment 4A. The system of Numbered Exemplary System Embodiment 4, wherein the recommended paging parameter schedule includes different recommended paging drx-Inactivity Timer values for different periods of time in the first region based on different paging loads determined to correspond to said different periods of time.

Numbered Exemplary System Embodiment 4AA. The system of Numbered Exemplary System Embodiment 4, wherein the recommended paging parameter schedule includes recommended paging parameters for multiple regions, said multiple regions including a first region (364), a second region (366) and a third region (368).

Numbered Exemplary System Embodiment 4B. The system of Numbered Exemplary System Embodiment 4A, wherein the recommended paging parameter schedule includes different paging parameters for multiple different time periods for each of said first, second and third regions.

Numbered Exemplary System Embodiment 5. The system of Numbered Exemplary System Embodiment 2, wherein the processor (1002) is further configured to control the analytics server to: generate (808 or 529) a paging setting recommendation for at least the first region based on the determined level of paging activity in the first region during the first period of time, generating the paging setting recommendation for at least the first region including: comparing (812 and/or 816) the determined level of paging activity in the first region to one or more paging load ranges to determine which of a plurality of paging load ranges, for which predetermined recommended paging parameters are stored, the determined level of paging activity in the first region corresponds; and recommend (822) a set of predetermined paging parameter values corresponding to the determined paging load range be used for the first region.

Numbered Exemplary System Embodiment 5A. The system of Numbered Exemplary System Embodiment 5, wherein the recommended set of predetermined paging parameter values includes at least a drx-onDuration Timer parameter value.

Numbered Exemplary System Embodiment 5B. The system of Numbered Exemplary System Embodiment 5, wherein the recommended set of predetermined paging parameter values includes a drx-onDuration Timer parameter value and a drx-Inactivity Timer parameter value.

Numbered Exemplary System Embodiment 6. The system of Numbered Exemplary System Embodiment 5, wherein plurality of paging load ranges for which predetermined recommended paging parameters are stored includes at least a high paging load range, a medium paging load range and a low paging load range.

Numbered Exemplary System Embodiment 7. The system of Numbered Exemplary System Embodiment 6, wherein the stored paging parameters corresponding to the high paging load range includes a high drx-onDuration Timer paging parameter value (e.g., 1200 ms) and a high drx-Inactivity Timer paging parameter value (e.g., 1280 ms).

Numbered Exemplary System Embodiment 8. The system of Numbered Exemplary System Embodiment 7, wherein the stored paging parameters corresponding to the medium paging load range include a medium drx-onDuration Timer paging parameter value (e.g., 600 ms) corresponding to a shorter on paging duration than the high drx-onDuration Timer paging parameter value (e.g., 1200 ms) and a medium drx-Inactivity Timer paging parameter value (e.g., 500 ms) corresponding to a shorter drx-Inactivity Timer time period than said high drx-Inactivity paging parameter value (e.g., 1280 ms).

Numbered Exemplary System Embodiment 9. The system of Numbered Exemplary System Embodiment 7, wherein the stored paging parameters corresponding to the low paging load range include a low drx-onDuration Timer paging parameter value (e.g., 300 ms) corresponding to a shorter on paging duration than the high drx-onDuration Timer paging parameter value and medium drx-onDuration Timer paging parameter values and a low drx-Inactivity Timer paging parameter value (e.g., 100 ms) corresponding to a shorter drx-Inactivity time period than said high drx-Inactivity Timer paging parameter value and said medium drx-Inactivity Timer paging parameter value.

Numbered Exemplary System Embodiment 10. The system of Numbered Exemplary System Embodiment 9, wherein generating (808 or 529) one or more paging setting recommendations includes generating paging setting recommendations for at least three different regions and at least 3 different hourly time periods.

### Non-Transitory Machine Readable Medium Embodiments

Numbered Exemplary Non-transitory Machine Readable Embodiment 1. A non-transitory machine readable medium (1020) including instructions which when executed by a processor (1002) of an analytics server (318) control the analytics server (318) to: store information indicating predetermined paging parameters values to be used for different paging load ranges; receive (804 or 526) a network activity report (524) including information corresponding to at least a first region (e.g., receive a network activity report (524) including information about network activity for one or more paging regions for one or more periods of time, where the report (524) in some cases includes network activity including paging information for a first, second and third region for a period of time including hours and/or days of traffic information representing multiple hourly periods of time including at least a first period of time corresponding to a first hour and day of a week for which network activity information including paging information is collected and provided in report 524) first paging region 1 364); analyze (e.g., determine)(806 or 528) the received network activity report (524) to determine a level of paging activity (e.g. paging load) during one or more periods of time for at least a first paging region (e.g., hourly periods during a day where the paging load is determined for at least a first paging region for a first time period), said one or more periods of time including at least a first period of time (e.g., first hourly period of a weekday, e.g., Monday, Tuesday, Wednesday, Thursday or Friday); generate (808 or 529) one or more paging setting recommendations (e.g., at least a first paging parameter recommendation for a first time period corresponding to the first region recommended paging parameters setting schedule), said step of generating one or more paging setting recommendations including generating a paging setting parameter recommendation for at least the first region based on the determined level of paging activity in the first region during the first period of time; and communicate (835 or 530) the paging setting recommendation to a management system (e.g., operations support system (OSS) (314) including configuration management functionality).

Various embodiments are directed to a non-transitory machine readable storage device, e.g., memory, with processor executable instructions stored thereon, which when executed by a processor of an apparatus, e.g., an analytics server, a core network node, performance evaluator server, operations support system (OSS), base station, or UE, control the apparatus to implement any one or more of the above described methods or numbered method embodiments.

The techniques of various embodiments may be implemented using software, hardware and/or a combination of software and hardware. Various embodiments are directed to apparatus, e.g., analytics servers, core network nodes, performance evaluator servers, operations support systems (OSSs), base stations, UEs, access points (AP), e.g., WiFi APs, supporting SCS and/or MSCS, stations (STAs), e.g., WiFi STAs, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to methods, e.g., method of controlling and/or operating analytics servers, core network nodes, performance evaluator servers, operations support systems (OSSs), base stations, UEs, access points (APs), e.g., WiFi APs, supporting SCS and/or MSCS, stations (STAs), e.g., WiFi STAs, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In some embodiments a buffer is implemented in the form of a queue. Thus, the terms buffers and queues are sometimes used to refer to the same thing.

In various embodiments devices, e.g., analytics servers, core network nodes, performance evaluator servers, operations support systems (OSSs), base stations, e.g. base stations which use 3GPP or non-3GPP technologies, UEs, access points (AP), e.g., WiFi APs, supporting SCS and/or MSCS, stations (STAs), e.g., WiFi STAs, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements described herein are implemented using one or more components to perform the steps corresponding to one or more methods, for example, provisioning APs, STAs, user equipment devices, provisioning AP devices, provisioning AAA servers, provisioning orchestration servers, generating messages, message reception, message transmission, signal processing, sending, comparing, determining and/or transmission steps. Thus, in some embodiments various features are implemented using components or, in some embodiments, logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., analytics servers, core network nodes, performance evaluator servers, operations support systems (OSSs), base stations, UEs, access points (AP), e.g., WiFi APs, supporting SCS and/or MSCS, stations (STAs), e.g., WiFi STAs, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, are configured to perform the steps of the methods described as being performed by the user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., analytics servers, core network nodes, performance evaluator servers, operations support systems (OSSs), base stations, UEs, access point (AP), e.g., WiFi AP, supporting SCS and/or MSCS, station (STA), e.g., WiFi STA, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, with a processor which includes a component corresponding to each of the steps of the various described methods performed by the device in which the processor is included. In some but not all embodiments a device, e.g., analytics server, core network node, network performance server, element management system (EMS), base station, UE, access points (AP), e.g., WiFi AP, supporting SCS and/or MSCS, stations (STA), e.g., WiFi STA, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., analytics server, core network node, performance evaluator server, operations support system (OSS), base station, UE, an access point (AP), e.g., WiFi AP, supporting SCS and/or MSCS, a stations (STA), e.g., a WiFi STA, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such an analytics server, core network node, performance evaluator server, operations support system (OSS), base station, UE, access point (AP), e.g., a WiFi AP, supporting SCS and/or MSCS, a station (STA), e.g., WiFi STA, supporting SCS and/or MSCS, a user equipment device, wireless device, mobile device, smartphone, subscriber device, desktop computer, printer, IPTV, laptop, tablets, network edge device, Access Point, wireless router, switch, WLAN controller, orchestration server, orchestrator, Gateway, AAA server, server, node and/or element or other device described in the present application. Additionally, proposed solution can be applied in a wide variety of different types of networks including but not limited to 3gpp or non-3gpp compliant networks.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method of controlling paging settings in a communications network, comprising:
receiving, at an analytics server, a network activity report including information corresponding to at least a first region;
analyzing the received network activity report to determine a level of paging activity during one or more periods of time for at least a first paging region, said one or more periods of time including at least a first period of time;
generating one or more paging setting recommendations, said step of generating one or more paging setting recommendations including generating a paging setting parameter recommendation for at least the first region based on the determined level of paging activity in the first region during the first period of time; and
communicating the paging setting recommendation to a management system.

2. The method of claim 1,
wherein the first period of time is a recurring period of time; and
wherein communicating the paging setting recommendation to the management system includes sending a recommended paging parameter schedule to the management system.

3. The method of claim 2, wherein the recommended paging parameter schedule includes a recommended paging drx-onDuration Timer value to be used for the first region during the first time period.

4. The method of claim 3, wherein the recommended paging parameter schedule includes different recommended paging drx-onDuration Timer values for different periods of time in the first region based on different paging loads determined to correspond to said different periods of time.

5. The method of claim 2, further comprising:
generating a paging setting recommendation for at least the first region based on the determined level of paging activity in the first region during the first period of time, generating the paging setting recommendation for at least the first region including:
comparing the determined level of paging activity in the first region to one or more paging load ranges to determine which of a plurality of paging load ranges, for which predetermined recommended paging parameters are stored, the determined level of paging activity in the first region corresponds; and
recommending a set of predetermined paging parameter values corresponding to the determined paging load range be used for the first region.

6. The method of claim 5, wherein plurality of paging load ranges for which predetermined recommended paging parameters are stored include at least a high paging load range, a medium paging load range and a low paging load range.

7. The method of claim 6, wherein the stored paging parameters, corresponding to the high paging load range, include a high drx-onDuration Timer paging parameter value and a high drx-Inactivity Timer paging parameter value.

8. The method of claim 7, wherein the stored paging parameters, corresponding to the medium paging load range, include a medium drx-onDuration Timer paging parameter value corresponding to a shorter on paging duration than the high drx-onDuration Timer paging parameter value and a medium drx-Inactivity Timer paging parameter value corresponding to a shorter drx-Inactivity Timer time period than said high drx-Inactivity paging parameter value.

9. The method of claim 7, wherein the stored paging parameters, corresponding to the low paging load range, include a low drx-onDuration Timer paging parameter value corresponding to a shorter on paging duration than the high drx-onDuration Timer paging parameter value and medium drx-onDuration Timer paging parameter values and a low drx-Inactivity Timer paging parameter value corresponding to a shorter drx-Inactivity time period than said high drx-Inactivity Timer paging parameter value and said medium drx-Inactivity Timer paging parameter value.

10. The method of claim 9, wherein generating one or more paging setting recommendations includes generating paging setting recommendations for at least three different regions and at least 3 different hourly time periods.

11. A system for controlling paging settings in a communications network (300), comprising:
an analytics server including:
memory storing information indicating predetermined paging parameters values to be used for different paging load ranges; and
a processor configured to control the analytics server to:
receive a network activity report including information corresponding to at least a first region;
analyze the received network activity report to determine a level of paging activity during one or more periods of time for at least a first paging region, said one or more periods of time including at least a first period of time;
generate one or more paging setting recommendations, said step of generating one or more paging setting recommendations including generating a paging setting parameter recommendation for at least the first region based on the determined level of paging activity in the first region during the first period of time; and
communicate the paging setting recommendation to a management system.

12. The system of claim 11,
wherein the first period of time is a recurring period of time; and
wherein the processor is configured to control the analytics server to send a recommended paging parameter schedule to the management system as part of being configured to control the analytics server to communicate the paging setting recommendation to the management system.

13. The system of claim 12, wherein the recommended paging parameter schedule includes a recommended paging drx-onDuration Timer value to be used for the first region during the first time period.

14. The system of claim 13, wherein the recommended paging parameter schedule includes different recommended paging drx-onDuration Timer values for different periods of time in the first region based on different paging loads determined to correspond to said different periods of time.

15. The system of claim 12, wherein the processor is further configured to control the analytics server to:
generate a paging setting recommendation for at least the first region based on the determined level of paging activity in the first region during the first period of time, generating the paging setting recommendation for at least the first region including controlling the analytics server to:
compare the determined level of paging activity in the first region to one or more paging load ranges to determine which of a plurality of paging load ranges, for which predetermined recommended paging parameters are stored, the determined level of paging activity in the first region corresponds; and
recommend a set of predetermined paging parameter values corresponding to the determined paging load range be used for the first region.

16. The system of claim 15, wherein plurality of paging load ranges for which predetermined recommended paging parameters are stored includes at least a high paging load range, a medium paging load range and a low paging load range.

17. The system of claim 16, wherein the stored paging parameters corresponding to the high paging load range includes a high drx-onDuration Timer paging parameter value and a high drx-Inactivity Timer paging parameter value.

18. The system of claim 17, wherein the stored paging parameters corresponding to the medium paging load range include a medium drx-onDuration Timer paging parameter value corresponding to a shorter on paging duration than the high drx-onDuration Timer paging parameter value and a medium drx-Inactivity Timer paging parameter value corresponding to a shorter drx-Inactivity Timer time period than said high drx-Inactivity paging parameter value.

19. The system of claim 17, wherein the stored paging parameters corresponding to the low paging load range include a low drx-onDuration Timer paging parameter value corresponding to a shorter on paging duration than the high drx-onDuration Timer paging parameter value and medium drx-onDuration Timer paging parameter values and a low drx-Inactivity Timer paging parameter value corresponding to a shorter drx-Inactivity time period than said high drx-Inactivity Timer paging parameter value and said medium drx-Inactivity Timer paging parameter value.

20. A non-transitory machine readable medium including instructions which when executed by a processor of an analytics server control the analytics server to:
store information indicating predetermined paging parameters values to be used for different paging load ranges;
receive a network activity report including information corresponding to at least a first region;
analyze the received network activity report to determine a level of paging activity during one or more periods of time for at least a first paging region, said one or more periods of time including at least a first period of time;
generate one or more paging setting recommendations (e.g., at least a first paging parameter recommendation for a first time period corresponding to the first region recommended paging parameters setting schedule), said step of generating one or more paging setting recommendations including generating a paging setting parameter recommendation for at least the first region based on the determined level of paging activity in the first region during the first period of time; and
communicate the paging setting recommendation to a management system.
